(19) United States
(12) Patent Application Publication
(10) Pub. No.: US 2026/0219742 A1
(43) Pub. Date: Jul. 30, 2026

(54) SMART RING DEVICE, METHOD, AND COMPUTER-READABLE STORAGE MEDIUM FOR IDENTIFYING WEARING DIRECTION

(71) Applicant: Samsung Electronics Co., Ltd., Suwon-si (KR)

(72) Inventors: Dongil SON, Suwon-si (KR); Geonsoo KIM, Suwon-si (KR); Hyunsoo KIM, Suwon-si (KR); Jeongmin PARK, Suwon-si (KR); Bokun CHOI, Suwon-si (KR); Minkyung HWANG, Suwon-si (KR)

(21) Appl. No.: 19/578,032

(22) Filed: Mar. 25, 2026

Related U.S. Application Data
(63) Continuation of application No. PCT/KR2024/011835, filed on Aug. 8, 2024.

(30) Foreign Application Priority Data
Sep. 27, 2023 (KR) 10-2023-0131265
Nov. 7, 2023 (KR) 10-2023-0152634

(51) Int. Cl. G06F 3/03; G06F 3/01; G06F 3/0346; G06F 3/0485

(52) U.S. Cl. CPC G06F 3/0325; G06F 3/014; G06F 3/0346; G06F 3/0485; G06F 2203/0331

(57) ABSTRACT

A smart ring device is provided. The smart ring device includes a housing including an external housing portion and an inner housing portion which is at least partially transparent, a light emitter configured to emit light through the inner housing portion, a first light receiver configured to receive the light reflected from at least a part of a finger of a user's finger, a second light receiver configured to receive the light reflected from at least a part of the user's finger, memory, including one or more storage media, storing instructions, and at least one processor including processing circuitry communicatively coupled to the memory, wherein the instructions, when executed by the at least one processor individually or collectively, cause the smart ring device to determine a wearing direction of the smart ring device by using a first signal identified by the first light receiver and a second signal identified by the second light receiver.

### CROSS-REFERENCE TO RELATED APPLICATION(S)

This application is a continuation application, claiming priority under 35 U.S.C. § 365(c), of an International application No. PCT/KR2024/011835, filed on Aug. 8, 2024, which is based on and claims the benefit of a Korean patent application number 10-2023-0131265, filed on Sep. 27, 2023, in the Ministry of Intellectual Property (MOIP), and of a Korean patent application number 10-2023-0152634, filed on Nov. 7, 2023, in the Ministry of Intellectual Property (MOIP), the disclosure of each of which is incorporated by reference herein in its entirety.

### BACKGROUND

### 1. Field

The disclosure relates to a smart ring device, a method, and a computer readable storage medium for identifying a wearing direction.

### 2. Description of Related Art

Various services are provided through a wearable device. The wearable device may be worn on a part of a user's body and may operate. The wearable device may identify biometric information of the user in a state of being worn on a part of the user's body and provide a service based on the biometric information of the user. The wearable device wearable on the user's finger may be referred to as a smart ring device.

The above information is presented as a background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a smart ring device, a method, and a computer readable storage medium for identifying a wearing direction.

Additional aspects will be set forth in part in the description which follows and, in part, will be apparent from the description, or may be learned by practice of the presented embodiments.

In accordance with an aspect of the disclosure, a smart ring device is provided. The smart ring device includes a housing including an external housing portion and an inner housing portion which is at least partially transparent, a light emitter configured to emit light through the inner housing portion, a first light receiver configured to receive the light reflected from at least a part of a user's finger, a second light receiver configured to receive the light reflected from the at least a part of the user's finger, memory, including one or more storage media, storing instructions, and at least one processor including processing circuitry communicatively coupled to the memory, wherein the instructions, when executed by the at least one processor individually or collectively, cause the smart ring device to determine a wearing direction of the smart ring device using a first signal identified by the first light receiver and a second signal identified by the second light receiver.

In accordance with another aspect of the disclosure, a method performed by a smart ring device is provided. The method includes emitting, using a light emitter included in the smart ring device, light, determining a wearing direction of the smart ring device using a first signal identified by a first light receiver comprised in the smart ring device based on the light reflected from at least a part of a user's finger and a second signal identified by a second light receiver comprised in the smart ring device based on the light reflected from the at least a part of the user's finger.

In accordance with another aspect of the disclosure, one or more non-transitory computer readable storage media storing one or more computer programs including computer-executable instructions, which, when executed by a processor of a smart ring device with a light emitter, a first light receiver, and a second light receiver, cause the smart ring device to emit, using the light emitter, light. The one or more programs include instructions that, when executed by the at least one processor of a smart ring device with a light emitter, a first light receiver, and a second light receiver individually or collectively, cause the smart ring device to perform operations are provided. The operations include emitting, using the light emitter, light, and determining a wearing direction of the smart ring device using a first signal identified by the first light receiver based on the light reflected from at least a part of a user's finger and a second signal identified by the second light receiver based on the light reflected from the at least a part of the user's finger.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2A illustrates a perspective view of a smart ring device according to an embodiment of the disclosure;

FIG. 2B illustrates a partial cross-sectional view of a smart ring device according to an embodiment of the disclosure;

FIG. 2C illustrates a rotatable structure of a smart ring device according to an embodiment of the disclosure;

FIG. 3 is a simplified block diagram of a smart ring device according to an embodiment of the disclosure;

FIG. 4 illustrates a light receiving circuit of a photoplethysmography (PPG) sensor according to an embodiment of the disclosure;

FIG. 5A illustrates a wearing direction of a smart ring device according to an embodiment of the disclosure;

FIG. 5B illustrates signals identified by light receivers of a smart ring device according to an embodiment of the disclosure;

FIG. 6A illustrates a wearing direction of a smart ring device according to an embodiment of the disclosure;

FIG. 6B illustrates signals identified by light receivers of a smart ring device according to an embodiment of the disclosure;

FIG. 7 illustrates a path of light emitted from a light emitter, according to an embodiment of the disclosure;

FIG. 8 illustrates a flowchart related to an operation of a smart ring device according to an embodiment of the disclosure;

FIG. 9 illustrates intensity of light emitted based on an operation mode of a smart ring device according to an embodiment of the disclosure;

FIG. 10 illustrates intensity of light emitted based on a surrounding environment of a smart ring device according to an embodiment of the disclosure;

FIG. 11 illustrates an operation of a smart ring device for identifying a wearing direction of the smart ring device according to an embodiment of the disclosure;

FIG. 12 illustrates a flowchart related to an operation of a smart ring device according to an embodiment of the disclosure;

FIG. 13 illustrates a screen representing a wearing direction of a smart ring device according to an embodiment of the disclosure;

FIG. 14A illustrates circuitry including a plurality of antennas for changing a direction of a radiated signal according to an embodiment of the disclosure;

FIG. 14B illustrates a signal radiated from a smart ring device according to an embodiment of the disclosure;

FIG. 15 illustrates a smart ring device is connected to an external electronic device according to an embodiment of the disclosure;

FIG. 16 illustrates a flowchart related to an operation of a smart ring device according to an embodiment of the disclosure;

FIG. 17A illustrates a scroll input through a smart ring device according to an embodiment of the disclosure;

FIG. 17B illustrates a scroll input through a smart ring device according to an embodiment of the disclosure;

FIG. 18 illustrates a rotation input through a smart ring device according to an embodiment of the disclosure;

FIG. 19 illustrates an operation for identifying a wearing direction of a smart ring device according to an embodiment of the disclosure;

FIG. 20 illustrates a smart ring device is connected to an external electronic device according to an embodiment of the disclosure;

FIG. 21A illustrates a connection between a smart ring device and an external electronic device according to an embodiment of the disclosure;

FIG. 21B illustrates a connection between a smart ring device and an external electronic device according to an embodiment of the disclosure;

FIG. 22 illustrates a connection between a smart ring device and an external electronic device according to an embodiment of the disclosure;

FIG. 23 illustrates a connection between a smart ring device and an external electronic device according to an embodiment of the disclosure;

FIG. 24 illustrates a perspective view of a smart ring device according to an embodiment of the disclosure;

FIG. 25 illustrates a smart ring device capable of being coupled with an external electronic device according to an embodiment of the disclosure;

FIG. 26 illustrates a smart ring device capable of being coupled with an external electronic device according to an embodiment of the disclosure;

FIG. 27 illustrates an operation of a smart ring device, a first external electronic device, and a second external electronic device according to an embodiment of the disclosure;

FIG. 28 illustrates a flowchart related to an operation of an external electronic device according to an embodiment of the disclosure;

FIG. 29 illustrates an operation of a smart ring device and an external electronic device according to an embodiment of the disclosure;

FIG. 30 illustrates an operation of a smart ring device and external electronic devices according to an embodiment of the disclosure;

FIG. 31 illustrates an operation of a smart ring device and external electronic devices according to an embodiment of the disclosure; and

FIG. 32 illustrates an operation of a plurality of smart ring devices and an external electronic device according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

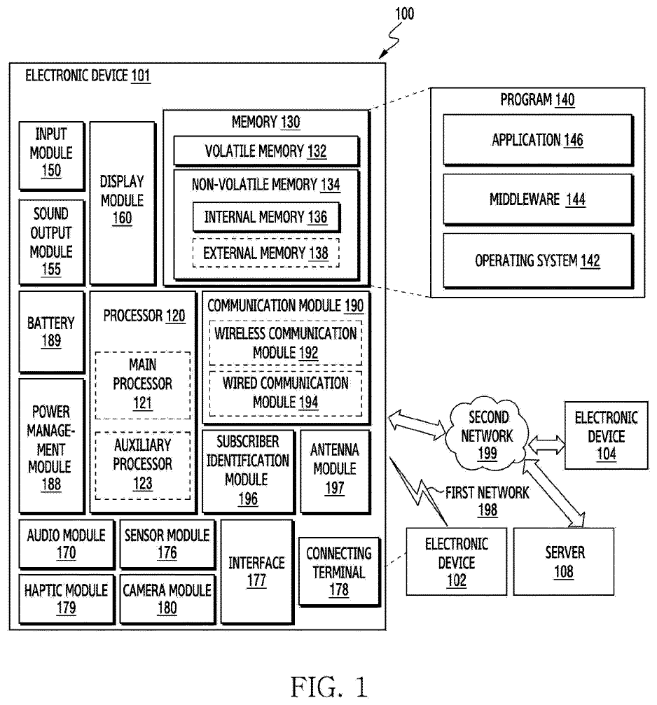

FIG. 1 is a block diagram illustrating an electronic device in a network environment according to an embodiment of the disclosure.

Referring to FIG. 1, an electronic device 101 in a network environment 100 may communicate with an external electronic device 102 via a first network 198 (e.g., a short-range wireless communication network), or at least one of an external electronic device 104 or a server 108 via a second network 199 (e.g., a long-range wireless communication network). According to an embodiment of the disclosure, the electronic device 101 may communicate with the external electronic device 104 via the server 108. According to an embodiment of the disclosure, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments of the disclosure, at least one of the components (e.g., the connecting terminal 178) may be omitted from the electronic device 101, or one or more other components may be added in the electronic device 101. In some embodiments of the disclosure, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment of the disclosure, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment of the disclosure, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., a sleep) state, or together with the main processor 121 while the main processor 121 is in an active state (e.g., executing an application). According to an embodiment of the disclosure, the auxiliary processor 123 (e.g., an image signal processor or a communication processor) may be implemented as part of another component (e.g., the camera module 180 or the communication module 190) functionally related to the auxiliary processor 123. According to an embodiment of the disclosure, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment of the disclosure, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment of the disclosure, the display module 160 may include a touch sensor adapted to detect a touch, or a pressure sensor adapted to measure the intensity of force incurred by the touch.

The audio module 170 may convert a sound into an electrical signal and vice versa. According to an embodiment of the disclosure, the audio module 170 may obtain the sound via the input module 150, or output the sound via the sound output module 155 or a headphone of an external electronic device (e.g., the external electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment of the disclosure, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly (e.g., wiredly) or wirelessly. According to an embodiment of the disclosure, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the external electronic device 102). According to an embodiment of the disclosure, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment of the disclosure, the haptic module 179 may include, for example, a motor, a piezoelectric element, or an electric stimulator.

The camera module 180 may capture a still image or moving images. According to an embodiment of the disclosure, the camera module 180 may include one or more lenses, image sensors, image signal processors, or flashes.

The power management module 188 may manage power supplied to the electronic device 101. According to an embodiment of the disclosure, the power management module 188 may be implemented as at least part of, for example, a power management integrated circuit (PMIC).

The battery 189 may supply power to at least one component of the electronic device 101. According to an embodiment of the disclosure, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment of the disclosure, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth-generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth-generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the external electronic device 104), or a network system (e.g., the second network 199). According to an embodiment of the disclosure, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment of the disclosure, the antenna module 197 may include an antenna including a radiating element including a conductive material or a conductive pattern formed in or on a substrate (e.g., a printed circuit board (PCB)). According to an embodiment of the disclosure, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment of the disclosure, another component (e.g., a radio frequency integrated circuit (RFIC)) other than the radiating element may be additionally formed as part of the antenna module 197.

According to various embodiments of the disclosure, the antenna module 197 may form a mmWave antenna module. According to an embodiment of the disclosure, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, commands or data may be transmitted or received between the electronic device 101 and the external electronic device 104 via the server 108 coupled with the second network 199. Each of the external electronic devices 102 or 104 may be a device of a same type as, or a different type, from the electronic device 101. According to an embodiment of the disclosure, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment of the disclosure, the external electronic device 104 may include an internet-of-things (IoT) device. The server 108 may be an intelligent server using machine learning and/or a neural network. According to an embodiment of the disclosure, the external electronic device 104 or the server 108 may be included in the second network 199. The electronic device 101 may be applied to intelligent services (e.g., a smart home, a smart city, a smart car, or healthcare) based on 5G communication technology or IoT-related technology.

Hereinafter, a smart ring device wearable on a user's finger will be described. The smart ring device described below may be an example of the electronic device 101 of FIG. 1. The smart ring device described below may include at least a part or all of the components of the electronic device 101 of FIG. 1.

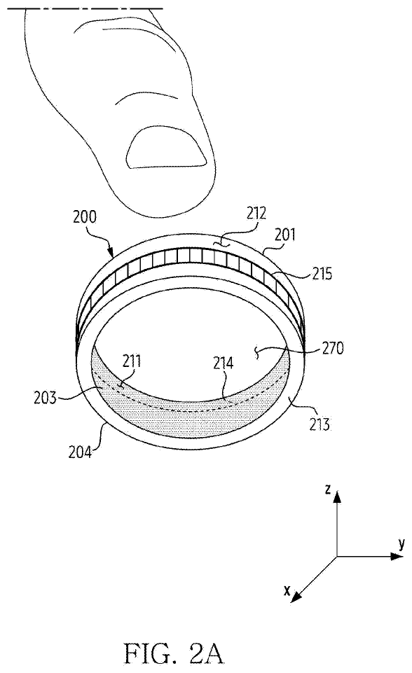

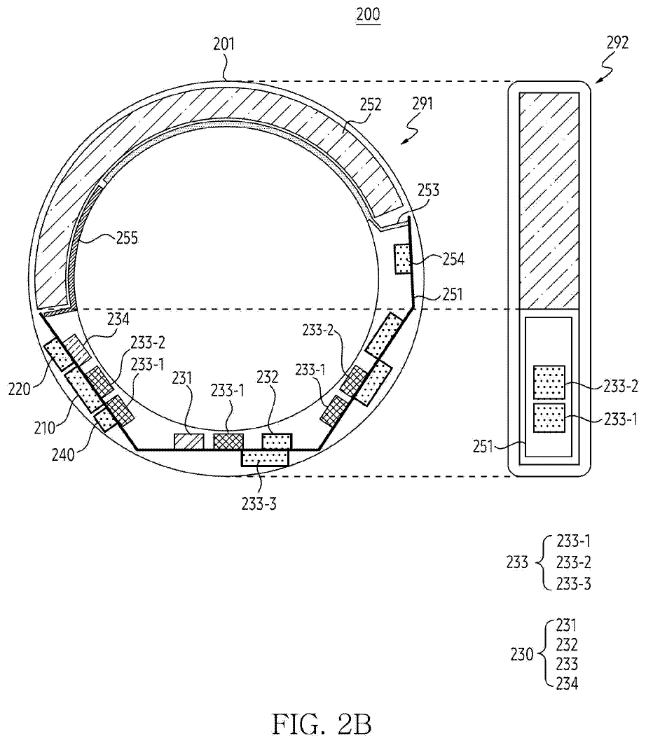

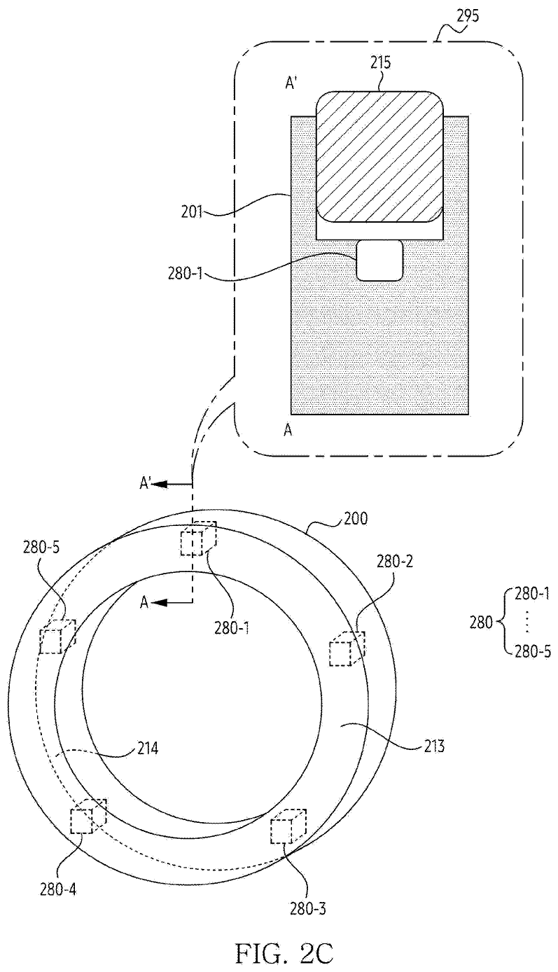

FIG. 2A illustrates a perspective view of a smart ring device according to an embodiment of the disclosure.

Referring to FIG. 2A, a smart ring device 200 may include a housing 201 including a first surface 211 facing a part (e.g., a finger) of a user's body and a second surface 212 opposite the first surface 211. The housing 201 may include side surfaces between the first surface 211 and the second surface 212. The side surfaces between the first surface 211 and the second surface 212 may include a first side surface 213 and a second side surface 214.

For example, the smart ring device 200 may include the ring-shaped housing 201. As an example, the smart ring device 200 may be configured in a ring shape. For example, the housing 201 may include an inner housing portion 203 to form the first surface 211 and an external housing portion 204 to form the second surface 212.

According to an embodiment of the disclosure, the smart ring device 200 may be referred to as a wearable device or an electronic device that may be worn by the user. The smart ring device 200 may be worn on a part (e.g., a finger) of the user's body. For example, the smart ring device 200 may be worn on the part of the user's body. For example, the smart ring device 200 may be fastened to a part of the user's body. For example, the smart ring device 200 may be detachable from the part of the user's body. For example, the smart ring device 200 may have a shape corresponding to the part of the user's body in order to be worn on the part of the user's body.

For example, the smart ring device 200 may be in contact with a part of the user's body by being worn by the user. For example, the smart ring device 200 may be configured to obtain information on the user through the part of the user's body by being worn by the user. As an example, the information on the user may include the user's health information. However, it is not limited thereto. The user's health information may include the user's heart rate and/or oxygen saturation. The smart ring device 200 may include a heart rate measurement (HRM) sensor for identifying (or measuring or monitoring) the user's heart rate and/or oxygen saturation. As an example, the information on the user may include the user's behavior information. The smart ring device 200 may identify (or measure or monitor) whether the user performs exercise and/or identify the user's posture.

For example, the smart ring device 200 may provide the information on the user through the smart ring device 200 and/or an external electronic device communicatively connected to the smart ring device 200. However, it is not limited thereto.

According to an embodiment of the disclosure, at least a part of the first surface 211 may be in contact with a part of the user's body in a case that the smart ring device 200 is worn by the user. For example, the first surface 211 may surround the part of the user's body wearing the smart ring device 200. For example, the first surface 211 may cover the part of the user's body wearing the smart ring device 200. For example, when the smart ring device 200 is worn by the user, the first surface 211 may be configured such that the smart ring device 200 is fastened to the part of the body by pressurizing the part of the user's body. For example, the first surface 211 may be deformable by the part of the user's body. For example, the smart ring device 200 may provide information on the user through the first surface 211 based on a haptic technology. As an example, the smart ring device 200 may provide information representing that the user's heart rate is greater than or equal to a specified heart rate by outputting vibration.

For example, the second surface 212 may form an exterior of the smart ring device 200 together with the first surface 211. For example, the second surface 212 may form the ring-shaped housing 201 together with the first surface 211. For example, the second surface 212 may be a surface spaced apart from the part of the user's body in a case that the smart ring device 200 is worn by the user. For example, the first surface 211 may be referred to as an inner circumference surface of the housing 201. The second surface 212 opposite the first surface 211 may be referred to as an outer circumference surface of the housing 201.

For example, the second surface 212 may be exposed to the outside in a state in which the smart ring device 200 is worn by the user. The second surface 212 may be configured with at least one of titanium, stainless steel, and ceramic. The second surface 212 may be configured with a material for protecting against an external impact and/or a scratch. According to an embodiment of the disclosure, the second surface 212 may be coated with an additional material for protecting a color of the smart ring device 200 and/or the exterior of the smart ring device 200.

For example, the first surface 211 may be configured with the same and/or similar material as the second surface 212. According to an embodiment of the disclosure, at least a part of the first surface 211 may be configured with at least one of a molding material, transparent plastic, and/or glass for obtaining data. For example, at least a part of the inner housing portion 203 may be transparent. According to an embodiment of the disclosure, at least a part of the first surface 211 may be configured with metal for identifying a bio-signal.

According to an embodiment of the disclosure, the smart ring device 200 may further include a hole 270, which is formed by the first surface 211 to pass through a part of the user's body when the smart ring device 200 is worn by the user. For example, in a case that the smart ring device 200 is worn by the user, the hole 270 may be penetrated by the part of the user's body. The smart ring device 200 may be configured to be fastened to the part of the user's body in a case that the user wears the smart ring device 200, by including the hole 270 configured to allow the part of the user's body to pass through.

According to an embodiment of the disclosure, the smart ring device 200 may further include one or more components between the first surface 211 and the second surface 212. For example, the smart ring device 200 may include one or more components between the first surface 211 and the second surface 212. A disposition of the one or more components will be described later in FIG. 2B.

According to an embodiment of the disclosure, the smart ring device 200 may include a structure 215 rotatable on the external housing portion 204 (or the second surface 212) based on a center of the hole 270 of the smart ring device 200. The structure 215 may be rotatable along the external housing portion 204. According to an operation of rotating the structure 215 by the user, a rotation input may be identified in the smart ring device 200. Based on the operation in which the user rotates the structure 215, the rotation input may be identified. The operation in which the user rotates the structure 215 may be referred to as the rotation input. A specific structure of the smart ring device 200 for identifying the rotation input will be described later in FIG. 2B.

FIG. 2B illustrates a partial cross-sectional view of a smart ring device according to an embodiment of the disclosure.

Referring to FIG. 2B, an example 291 is a partial cross-sectional view of a smart ring device 200 viewed in an x-axis direction of FIG. 2A. An example 292 is a partial cross-sectional view of the smart ring device 200 viewed in a y-axis direction of FIG. 2A.

In the example 291, the smart ring device 200 may be formed in a ring shape. For example, a housing 201 of the smart ring device 200 may be formed in a ring shape that may be worn on a user's finger. In FIGS. 2A and 2B, the ring-shaped smart ring device 200 with a smooth surface is illustrated as an example, but is not limited thereto. For example, the smart ring device 200 may be implemented as a housing including a plurality of planes. For example, the ring-shaped smart ring device 200 with an unsmooth surface may also be understood as an embodiment of the disclosure.

According to an embodiment of the disclosure, the ring-shaped housing 201 may include a first surface 211 in contact with a user's body in a state of being worn by the user, a second surface 212 exposed to the outside, and side surfaces between the first surface 211 and the second surface 212. The side surfaces between the first surface 211 and the second surface 212 may include a first side surface 213 and a second side surface 214. For example, a space for including (or disposing) at least one component (e.g., a processor 210, communication circuitry 220, an acceleration sensor 231, a gyro sensor 232, a PPG sensor 233, a temperature sensor 234, and/or memory 240) may be included between the first surface 211 and the second surface 212.

According to an embodiment of the disclosure, a PCB 251 may be disposed between the first surface 211 and the second surface 212 of the smart ring device 200. For example, the processor 210, the communication circuitry 220, the acceleration sensor 231, the gyro sensor 232, the PPG sensor 233, the temperature sensor 234, the memory 240, and/or a PMIC 254 may be disposed on the PCB 251. For example, the PCB 251 may be formed of a rigid region and a flexible region. As an example, the rigid region may be referred to as a rigid flexible printed circuit board (RFPCB). As an example, the flexible region may be referred to as a flexible printed circuit board (FPCB).

For example, the PPG sensor 233 may include one or more light emitting circuits 233-1, one or more light receiving circuits 233-2, and a control circuit 233-3. As an example, the one or more light emitting circuits 233-1 and one or more light receiving circuits 233-2 may be disposed toward the first surface 211. As an example, the control circuit 233-3 may be disposed toward the second surface 212. The example 292 illustrates a side view of the smart ring device 200. In the example 292, the one or more light emitting circuits 233-1 and the one or more light receiving circuits 233-2 may be disposed in different positions in the smart ring device 200. For example, the number of the one or more light emitting circuits 233-1 and the number of the one or more light receiving circuits 233-2 may be configured differently. According to an embodiment of the disclosure, the number of the one or more light emitting circuits 233-1 and the number of the one or more light receiving circuits 233-2 may also be configured to be the same. For example, the one or more light receiving circuits 233-2 corresponding to each of the one or more light emitting circuits 233-1 may be configured in the smart ring device 200.

For example, the temperature sensor 234 may be used to measure (or detect or identify) a temperature of a part of the user's body or a temperature of a component of the smart ring device 200. The temperature sensor 234 may include one of a contact type temperature sensor and a non-contact type temperature sensor.

For example, the PMIC 254 may be used to manage power of the smart ring device 200. The PMIC 254 may be used to provide (or distribute) power to components requiring power in the smart ring device 200. The PMIC 254 may support, through a charging interface 253, a wired charging method (e.g., a terminal or a pogo pin) or a wireless charging method (e.g., wireless power consortium (WPC) or NFC) for charging the smart ring device 200.

According to an embodiment of the disclosure, a battery 252 may be disposed between the first surface 211 and the second surface 212 of the smart ring device 200. The battery 252 may be configured with at least one battery (or battery pack). For example, the battery 252 may be configured such that the at least one battery is connected in series and/or in parallel. For example, the battery 252 may be configured with a flexible battery pack. For example, the battery 252, which is a secondary battery, may be charged and/or discharged. For example, a material configuring the battery 252 may be variously configured. As an example, the material configuring the battery 252 may include at least one of lithium ion and mercury.

According to an embodiment of the disclosure, an antenna 255 may be disposed between the first surface 211 and the second surface 212 of the smart ring device 200. For example, the antenna 255 may configured with a single antenna and/or a plurality of segment antennas. According to an embodiment of the disclosure, the antenna 255 may be configured as a part of the housing 201 of the smart ring device 200. For example, the antenna 255 may be electrically connected to the communication circuitry 220 through the PCB 251. For example, the antenna 255 may include a first antenna configured to emit a signal based on a first direction and a second antenna configured to emit a signal based on a second direction opposite the first direction. At least one of the first antenna and the second antenna may be activated according to a wearing direction of the smart ring device 200.

FIG. 2B illustrates components included inside the smart ring device 200, but it is not limited thereto. Although not illustrated, the smart ring device 200 may further include various components in addition to the illustrated components. For example, the smart ring device 200 may further include a rotation detection sensor for identifying a rotation input according to rotation of a structure 215. The rotation detection sensor will be described later in FIG. 2C. For example, the smart ring device 200 may include a display. The display may be disposed on an outer surface of the housing 201.

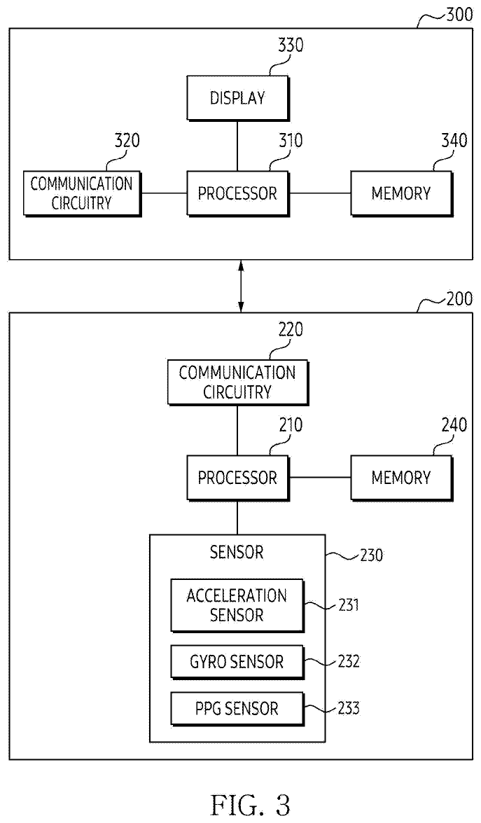

According to an embodiment of the disclosure, a specific description of at least one component (e.g., the processor 210, the communication circuitry 220, the PPG sensor 233, and/or the memory 240) for identifying the wearing direction of the smart ring device 200 will be described later in FIG. 3.

FIG. 2C illustrates a rotatable structure of a smart ring device according to an embodiment of the disclosure.

Referring to FIG. 2C, a smart ring device 200 may include a structure 215 rotatable on an external housing portion 204 (or a second surface 212) of a housing 201. The structure 215 may be configured to be rotatable along the external housing portion 204. For example, the housing 201 may be referred to as an inner ring. The structure 215 may be referred to as an outer ring.

According to an embodiment of the disclosure, a rotation input may be identified according to rotation of the structure 215. In order to identify the rotation of the structure 215, one or more rotation detection sensors 280 may be included. The one or more rotation detection sensors 280 may be disposed between a first surface 211 and the second surface 212. For example, the structure 215 may be configured with a material having magnetism (or a magnetic material). Based on a change in a magnetic field identified by the one or more rotation detection sensors 280 due to rotation of the structure 215, the rotation input may be identified. The one or more rotation detection sensors 280 may identify rotation speed and a rotation direction of the structure 215.

For example, the one or more rotation detection sensors 280 may include rotation detection sensors 280-1 to 280-5. The rotation detection sensor 280-1 to the rotation detection sensor 280-5 may be disposed in the smart ring device 200 at the same or similar interval. However, it is not limited thereto. FIG. 2C illustrates an example in which the number of the one or more rotation detection sensors 280 is configured to be five, but is not limited thereto. The number of the one or more rotation detection sensors 280 may be variously configured.

An example 295 represents a cross-sectional view of A-A′. In the example 295, the structure 215 may be rotated in a gap of the housing 201 of the smart ring device 200. The structure 215 may be at least partially spaced apart from the housing 201. Although not illustrated, the structure 215 may further include a connecting member rotatably connecting the structure 215 in the gap of the housing 201. According to an embodiment of the disclosure, the smart ring device 200 may further include a guide member for guiding the rotation of the structure 215. The guide member may be configured such that the structure 215 rotates discontinuously. For example, the guide member may include a crown gear.

According to an embodiment of the disclosure, the smart ring device 200 may identify (or determine) a moving direction of the structure 215. For example, the smart ring device 200 may identify that the structure 215 moves in a first direction (e.g., clockwise) based on a part of the structure 215 moving from the rotation detection sensor 280-1 to the rotation detection sensor 280-2. For example, the smart ring device 200 may identify that the structure 215 moves in a second direction (e.g., counterclockwise) based on a part of the structure 215 moving from the rotation detection sensor 280-1 to the rotation detection sensor 280-5.

Components of the smart ring device 200 or a structure (e.g., an external structure or an internal structure) of the smart ring device 200 may be variously changed according to an embodiment. For example, the smart ring device 200 may not include the structure 215. The smart ring device 200 may further include a touch sensor for identifying contact of a user's body on the external housing portion 204. The smart ring device 200 may identify a touch input using the touch sensor. The smart ring device 200 may identify a direction of the touch input. The smart ring device 200 may identify, based on the touch input, a rotation direction and/or a rotation amount of the rotation input.

According to an embodiment of the disclosure, the smart ring device 200 may not only be used to obtain information on the user, but may also be used to control an external electronic device connected to the smart ring device 200. The smart ring device 200 may identify the rotation input based on the rotation of the rotatable structure 215 included in the smart ring device 200. The smart ring device 200 may control the external electronic device based on the rotation input. However, as the smart ring device 200 is configured in a ring shape, a wearing direction may be changed. A direction of the rotation input may be changed according to the wearing direction of the smart ring device 200. In a case that the user of the smart ring device 200 performs the rotation input in a state of wearing the smart ring device 200, the smart ring device 200 may identify the rotation input as different inputs according to the wearing direction. Therefore, a technical feature for identifying the wearing direction of the smart ring device 200 will be described below.

FIG. 3 is a simplified block diagram of a smart ring device according to an embodiment of the disclosure.

Referring to FIG. 3, a smart ring device 200 may include a processor 210, communication circuitry 220, a sensor 230, and/or memory 240. According to an embodiment of the disclosure, the smart ring device 200 may include at least one of the processor 210, communication circuitry 220, the sensor 230, and/or the memory 240. For example, at least a part of the processor 210, the communication circuitry 220, the sensor 230, and/or the memory 240 may be omitted according to an embodiment. For example, the smart ring device 200 may correspond to the electronic device 101 of FIG. 1. For example, the smart ring device 200 may include at least a part of the components of the electronic device 101 of FIG. 1.

According to an embodiment of the disclosure, the processor 210 may correspond to the processor 120 of FIG. 1. The processor 210 may be operatively (or operably) coupled with or connected with the communication circuitry 220, the sensor 230, and the memory 240. The processor 210 being operatively coupled with or connected with the communication circuitry 220, the sensor 230, and the memory 240 may mean that the processor 210 may control the communication circuitry 220, the sensor 230, and the memory 240. For example, the communication circuitry 220, the sensor 230, and the memory 240 may be controlled by the processor 210.

Although illustrated based on different blocks, an embodiment is not limited thereto, and a part of hardware of FIG. 3 (e.g., at least a part of the processor 210, the communication circuitry 220, and the memory 240) may be included in a single integrated circuit, such as a system on a chip (SoC).

According to an embodiment of the disclosure, the processor 210 may be configured with at least one processor. For example, the processor 210 may be configured with a main processor performing high-performance processing and an auxiliary processor performing low-power processing. At least a part of the sensor 230 may be connected to the auxiliary processor. At least a part of the sensor connected to the auxiliary processor may obtain data on a user for 24 hours. According to an embodiment of the disclosure, one of the main processor and the auxiliary processor may be activated according to a state and/or an operation of an external electronic device 300. For example, a processor to be activated may be determined according to a state and/or an operation of the external electronic device 300. As an example, in a case that a battery of the external electronic device 300 is insufficient or in a case that the external electronic device 300 is changed to a sleep state (e.g., a state in which at least some functions are deactivated), the auxiliary processor for low-power processing may be activated. For example, in a case that accurate data on the user is required, the main processor may be activated to perform high-performance processing.

According to an embodiment of the disclosure, the processor 210 may include a hardware component for processing data based on one or more instructions. The hardware component for processing data may include, for example, an arithmetic and logic unit (ALU), a field programmable gate array (FPGA), and/or a central processing unit (CPU).

For example, the processor 210 may include an application processor, a supplementary processor (e.g., a sensor hub, a microcontroller unit (MCU)), a central processor unit (CPU), a neural processing unit (NPU), a graphics processing unit (GPU), and/or a processor for IoT (e.g., a processor integrated with a communication module).

According to an embodiment of the disclosure, the processor 210 may determine an operation timing of the sensor 230. The processor 210 may control an operation of the sensor 230. The processor 210 may process information obtained from the sensor 230.

According to an embodiment of the disclosure, the smart ring device 200 may include the communication circuitry 220. The communication circuitry 220 may correspond to at least a part of the communication module 190 of FIG. 1. For example, the communication circuitry 220 may be used for various radio access technologies (RATs). For example, the communication circuitry 220 may be used to perform Bluetooth communication, wireless local area network (WLAN) communication, Zigbee communication, near field communication (NFC), ultra wide band (UWB) communication, radio-frequency identification (RFID) communication, or ANT+ communication. For example, the communication circuitry 220 may be used to perform cellular communication (e.g., fourth generation (4G) communication, fifth generation (5G) communication, sixth generation (6G) communication, or narrowband IoT (NB-IoT)). For example, the processor 210 may establish a connection with an external electronic device through the communication circuitry 220. For example, the processor 210 may identify (or measure) a position of the smart ring device 200 based on a wireless signal (e.g., a global positioning system (GPS) signal or a global navigation satellite system (GNSS) signal) received or transmitted using the communication circuitry 220. According to an embodiment of the disclosure, the communication circuitry 220 may be configured to be integrated with the processor 210.

According to an embodiment of the disclosure, the smart ring device 200 may include the sensor 230. The sensor 230 may be used to obtain various information. For example, the sensor 230 may be used to obtain information on the user. The information on the user may include data on the user's body. As an example, the sensor 230 may be used to obtain body temperature data (or body temperature information), heart rate data (or heart rate information), and/or motion data (or motion information) of the user. For example, the sensor 230 may configured with at least one sensor. The sensor 230 may include at least one sensor. For example, the sensor 230 may correspond to the sensor module 176 of FIG. 1.

For example, the sensor 230 may include an acceleration sensor 231. The acceleration sensor 231 may be used to identify a change in acceleration of the smart ring device 200. As an example, the acceleration sensor 231 may identify (or measure or detect) acceleration of the smart ring device 200 in three directions of an x-axis, a y-axis, and a z-axis.

For example, the sensor 230 may include a gyro sensor 232. The gyro sensor 232 may identify (or measure or detect) angular velocity of the smart ring device 200 in the three directions of the x-axis, the y-axis, and the z-axis. According to an embodiment of the disclosure, the smart ring device 200 may include an inertial sensor including the acceleration sensor 231 and the gyro sensor 232.

For example, the smart ring device 200 may identify at least one of data on a movement of the smart ring device 200, data on the user's gesture, data on an amount of impact, data on a wearing direction of the smart ring device 200, data on a posture (or an orientation) of the smart ring device 200, and/or activity information of the user (e.g., sitting, movement, sports activity) by using at least one of the acceleration sensor 231 and/or the gyro sensor 232.

For example, the sensor 230 may include a photoplethysmography (PPG) sensor 233. The PPG sensor 233 may be used to measure a pulse (or a change in an amount of blood in a blood vessel) by identifying an amount of change in light intensity according to a change in blood vessel volume. The PPG sensor 233 may include one or more photodiodes (PDs) and one or more light emitting diodes (LEDs). For example, the PPG sensor 233 may be used to identify a change in a blood flow amount in a blood vessel during a heartbeat. The PPG sensor 233 may identify a change in a blood flow amount in a blood vessel during a heartbeat in a state in which an optical sensor is in contact with skin over a peripheral blood vessel. The processor 210 may identify a blood flow amount and identify a change in the blood flow amount based on a PPG signal and a waveform.

For example, the PPG sensor 233 may include a transmissive PPG sensor and/or a reflective PPG sensor.

As an example, the PPG sensor 233 may output light toward the user's skin through one of an LED (e.g., green, red, or infrared (IR)), a laser, and a vertical cavity surface emitting laser (VCSEL). The PPG sensor 233 may identify light reflected and/or transmitted from the user's skin through at least one of a PD and/or a complementary metal oxide semiconductor (CMOS) camera. Based on the reflected and/or transmitted light, the PPG sensor 233 may store a value identified through an analog to digital converter (ADC) in the memory 240 (or a buffer).

As an example, the transmissive PPG sensor may identify light transmitted through a blood vessel through a PD disposed on an opposite side of the LED. The transmissive PPG sensor may identify the user's blood flow amount based on intensity of the light transmitted through the blood vessel. As an example, the reflective PPG sensor may output light toward the user's skin through the LED. The reflective PPG sensor may identify light, reflected from a blood vessel and at least partially received, through a PD disposed on substantially the same surface as the LED. The reflective PPG sensor may identify the user's blood flow amount based on intensity of the light reflected from the blood vessel. For example, a multi-light source may be used as the LED. For example, green light, which is a complementary color to blood, may be used as the LED.

Although not illustrated, the sensor 230 may further include various sensors (e.g., a temperature sensor) for obtaining (or identifying, measuring, or detecting) various data on the user and/or the smart ring device 200. Although not illustrated, in a case that the smart ring device 200 includes a structure 215, the sensor 230 may further include one or more rotation detection sensors (e.g., the rotation detection sensors 280 of FIG. 2C).

According to an embodiment of the disclosure, the smart ring device 200 may include the memory 240. The memory 240 may be used to store information or data. For example, the memory 240 may be used to store data obtained from the user. For example, the memory 240 may correspond to the memory 130 of FIG. 1. For example, the memory 240 may be volatile memory unit or units. For example, the memory 240 may be non-volatile memory unit or units. For another example, the memory 240 may be another type of a computer readable medium, such as a magnetic or optical disk. For example, the memory 240 may store data obtained based on an operation (e.g., an algorithm execution operation) performed by the processor 210. For example, the memory 240 may store the data (e.g., the information on the user) obtained from the sensor 230. According to an embodiment of the disclosure, the memory 240 may be configured in an integrated form with the processor 210.

Although not illustrated in FIG. 3, the smart ring device 200 may further include various components. For example, as illustrated in FIG. 2B, the smart ring device 200 may further include at least one of the antenna 255, the power management integrated circuit (PMIC) 254, the battery 252, and the flexible printed circuit board (FPCB). According to an embodiment of the disclosure, the smart ring device 200 may further include a biometric sensor (e.g., an ECG sensor) including the PPG sensor 233.

According to an embodiment of the disclosure, the smart ring device 200 may further include various components in addition to the illustrated components. According to an embodiment of the disclosure, the smart ring device 200 may further include a display.

According to an embodiment of the disclosure, the smart ring device 200 may operate in a state of being connected to the external electronic device 300. For example, the smart ring device 200 may be used to perform an input of the external electronic device 300.

According to an embodiment of the disclosure, the external electronic device 300 may include a processor 310, communication circuitry 320, a display 330, and/or memory 340. According to an embodiment of the disclosure, the external electronic device 300 may include at least one of the processor 310, the communication circuitry 320, the display 330, and the memory 340. For example, at least a part of the processor 310, the communication circuitry 320, the display 330, and the memory 340 may be omitted according to an embodiment. For example, the external electronic device 300 may include at least a part of the components of the electronic device 101 of FIG. 1.

For example, the processor 310 of the external electronic device 300 may correspond to the processor 210 of the smart ring device 200. The communication circuitry 320 of the external electronic device 300 may correspond to the communication circuitry 220 of the smart ring device 200. The memory 340 of the external electronic device 300 may correspond to the memory 240 of the smart ring device 200.

For example, the external electronic device 300 may include the display 330. The display 330 may output visualized information to the user. For example, the display 330 may output visualized information to the user by being controlled by the processor 360 including circuitry, such as a graphics processing unit (GPU). For example, the display 330 may correspond to the display module 160 of FIG. 1.

According to an embodiment of the disclosure, the memory 340 of the external electronic device 300 may store instructions for processing a user input (e.g., a rotation input) received from the smart ring device 200. For example, a function for processing the rotation input according to the instructions may be in a deactivated state before being connected with the smart ring device 200. The function for processing the rotation input may be activated based on the connection with the smart ring device 200.

According to an embodiment of the disclosure, the external electronic device 300 may include a rotary bezel or a rotary structure. For example, the rotary structure may be configured based on a crown type (or a crown gear). The memory 340 may store instructions for processing a user input received (or identified) from the external electronic device 300 or a user input received (or identified) from the smart ring device 200.

According to an embodiment of the disclosure, in a case that the external electronic device 300 is a smart watch, the connection between the external electronic device 300 and the smart ring device 200 may be managed by another external electronic device (not illustrated) (e.g., a terminal or a smartphone). According to an embodiment of the disclosure, in a case that the external electronic device 300 is the smart watch, the external electronic device 300 may identify a rotation input as well as a general touch input (e.g., a press input, a long-press input, a double tap input, or a drag input). The external electronic device 300 configured in a circular shape may include a physical rotary bezel, or may include a virtual rotary bezel touchable along a housing of the external electronic device 300.

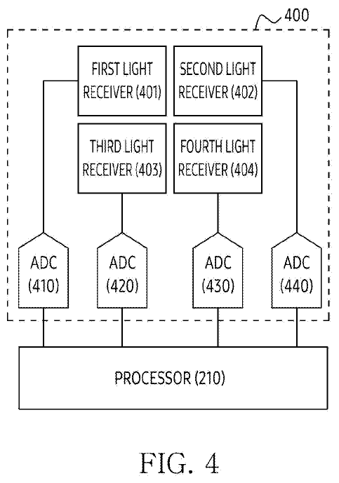

FIG. 4 illustrates a light receiving circuit of a PPG sensor according to an embodiment of the disclosure.

Referring to FIG. 4, a PPG sensor 233 may include a light receiving circuit 400. For example, the light receiving circuit 400 may be an example of a light receiving circuit among the one or more light receiving circuits 233-2 illustrated in FIG. 2B.

According to an embodiment of the disclosure, the light receiving circuit 400 may include one or more light receivers. For example, the light receiving circuit 400 may include four light receivers. The light receiving circuit 400 may include a first light receiver 401, a second light receiver 402, a third light receiver 403, and a fourth light receiver 404. FIG. 4 illustrates an example in which the light receiving circuit 400 includes four light receivers, but it is not limited thereto. The light receiving circuit 400 may include only the first light receiver 401 and the second light receiver 402.

The first light receiver 401 may be connected to a processor 210 through an ADC 410. The second light receiver 402 may be connected to the processor 210 through an ADC 420. The third light receiver 403 may be connected to the processor 210 through an ADC 430. The fourth light receiver 404 may be connected to the processor 210 through an ADC 440. The ADC 410 to ADC 440 may be used to convert an analog signal related to light identified by each of the first light receiver 401 to the fourth light receiver 404 into a digital signal.

For example, each of the first light receiver 401 to the fourth light receiver 404 may include at least one photodiode (or PD). Each of the first light receiver 401 to the fourth light receiver 404 may be configured with at least one photodiode. As an example, the first light receiver 401 may include at least one photodiode. The second light receiver 402 may include at least one other photodiode.

According to an embodiment of the disclosure, the processor 210 may identify first signal using the first light receiver 401. The processor 210 may identify a second signal using the second light receiver 402. The processor 210 may identify a third signal using the third light receiver 403. The processor 210 may identify a fourth signal using the fourth light receiver 404. For example, the first signal may include a first value for intensity of light, the light being emitted through a light emitting circuit 233-1 and reflected from at least a part of a user's finger. The second signal may include a second value for intensity of light, the light being emitted through the light emitting circuit 233-1 and reflected from at least a part of the user's finger. The third signal may include a third value for intensity of light, the light being emitted through the light emitting circuit 233-1 and reflected from at least a part of the user's finger. The fourth signal may include a fourth value for intensity of light, the light being emitted through the light emitting circuit 233-1 and reflected from at least a part of the user's finger.

According to an embodiment of the disclosure, the processor 210 may identify wearing direction of a smart ring device 200 by using at least one of the first signal to the fourth signal. Hereinafter, an example of an operation of the smart ring device 200 for identifying the wearing direction of the smart ring device 200 using at least one of the first signal to the fourth signal will be described.

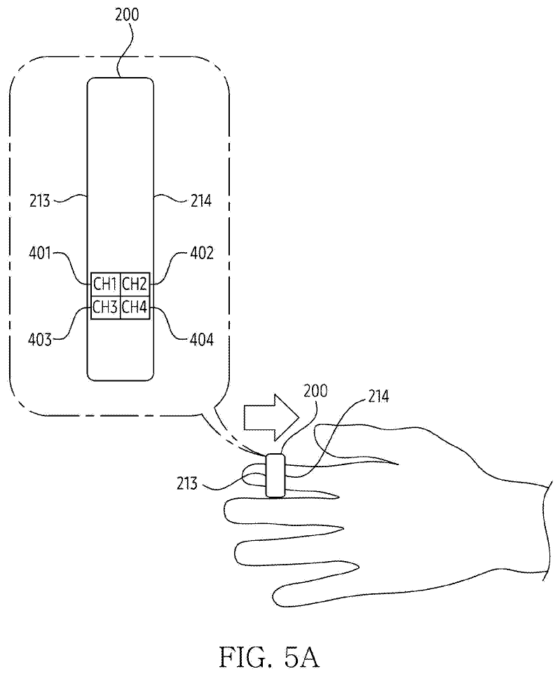

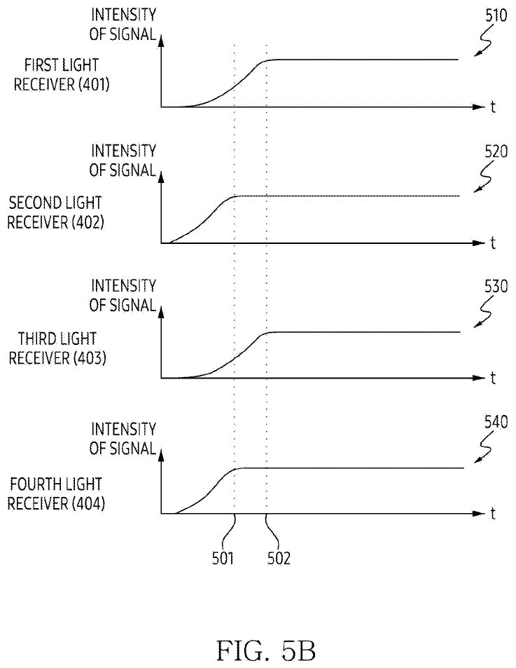

FIG. 5A illustrates a wearing direction of a smart ring device according to an embodiment of the disclosure.

FIG. 5B illustrates signals identified by light receivers of a smart ring device according to an embodiment of the disclosure.

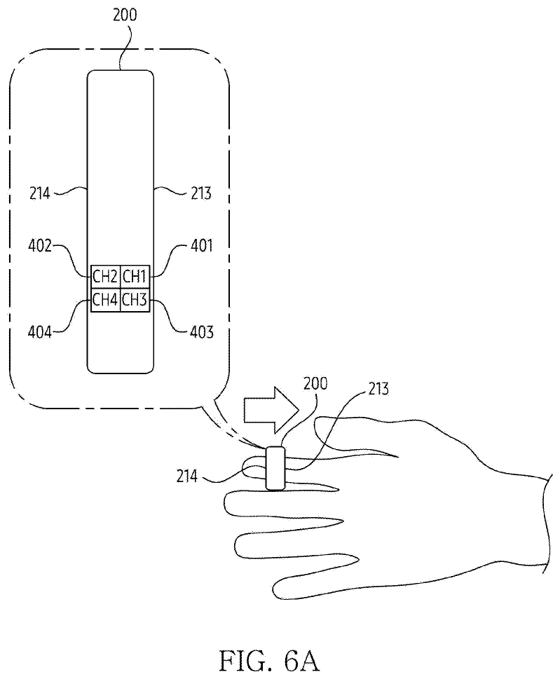

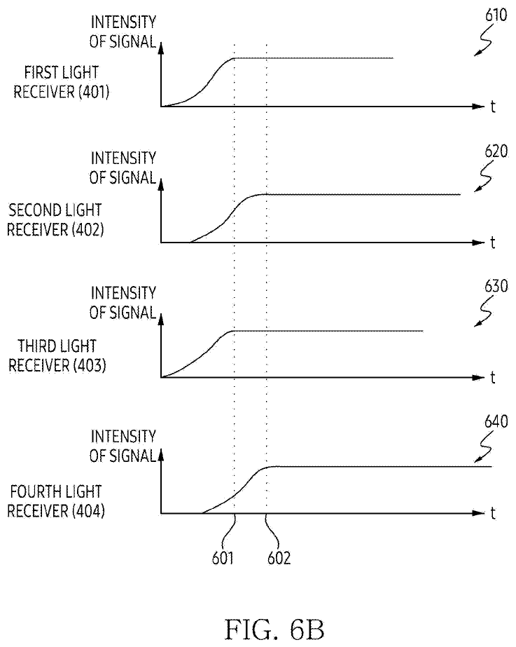

FIG. 6A illustrates a wearing direction of a smart ring device according to an embodiment of the disclosure.

FIG. 6B illustrates signals identified by light receivers of a smart ring device according to an embodiment of the disclosure.

Referring to FIGS. 5A and 6A, a smart ring device 200 may be worn in one of a first direction and a second direction. For example, a wearing direction of the smart ring device 200 may include the first direction and the second direction. FIG. 5A illustrates a case that the smart ring device 200 is worn in the first direction. FIG. 6A illustrates a case that the smart ring device 200 is worn in the second direction. Since there is no limitation on the wearing direction, the smart ring device 200 may be worn in one wearing direction among the first direction and the second direction.

Referring to FIG. 5A, in a case that the smart ring device 200 is worn in the first direction, a direction in which a first side surface 213 faces may correspond to a direction in which a finger on which the smart ring device 200 is worn faces. In a case that the smart ring device 200 is worn in the first direction, a second side surface 214 may approach the finger earlier than the first side surface 213. In a state in which the smart ring device 200 is worn in the first direction, the second side surface 214 may be disposed toward a dorsum of a hand. The first side surface 213 may be disposed toward a nail.

Referring to FIG. 6A, in a case that the smart ring device 200 is worn in the second direction, a direction in which the second side surface 214 faces may correspond to a direction in which the finger on which the smart ring device 200 is worn faces. In a case that the smart ring device 200 is worn in the second direction, the first side surface 213 may approach the finger earlier than the second side surface 214. In a state in which the smart ring device 200 is worn in the second direction, the first side surface 213 may be disposed toward the dorsum of the hand. The second side surface 214 may be disposed toward the nail.

Referring to FIGS. 5A and 6A, as illustrated in FIG. 2B, a light receiving circuit 400 may be disposed on at least a part of a first surface 211. Light emitted from one or more light emitting circuits 233-1 of a PPG sensor 233 may be reflected from the user's finger. The light receiving circuit 400 (or one or more light receiving circuits 233-2) may identify (or detect) the reflected light.

For example, the light receiving circuit 400 may include a first light receiver 401, a second light receiver 402, a third light receiver 403, and a fourth light receiver 404. The first light receiver 401 and the third light receiver 403 may be disposed closer to the first side surface 213 than the second side surface 214. The second light receiver 402 and the fourth light receiver 404 may be disposed closer to the second side surface 214 than the first side surface 213. Therefore, signals identified by a plurality of light receivers (e.g., the first light receiver 401, the second light receiver 402, the third light receiver 403, and the fourth light receiver 404) may differ according to the wearing direction of the smart ring device 200. For example, in a case that the smart ring device 200 is worn in the first direction, signals identified by the plurality of light receivers of the light receiving circuit 400 may be identified (or configured) as illustrated in FIG. 5B. In a case that the smart ring device 200 is worn in the second direction, signals identified by the plurality of light receivers of the light receiving circuit 400 may be identified (or configured) as illustrated in FIG. 6B.

Referring to FIG. 5B, a graph 510 represents intensity of a first signal identified through the first light receiver 401 over time. A graph 520 represents intensity of a second signal identified through the second light receiver 402 over time. A graph 530 represents intensity of a third signal identified through the third light receiver 403 over time. A graph 540 represents intensity of a fourth signal identified through the fourth light receiver 404 over time.

A timing at which intensity of a signal becomes saturated according to wearing of the smart ring device 200 may be different for each of light receivers. For example, in a case that the smart ring device 200 is worn in the first direction, the second side surface 214 may approach the user's finger first.

For example, the processor 210 may identify an amount of change in the first signal (or a first value for light intensity) and an amount of change in the second signal (or a second value for light intensity) at a specified timing (e.g., a timing 501). At the specified timing (e.g., the timing 501), the amount of change in the first signal (or the first value for the light intensity) may be less than the amount of change in the second signal (or the second value for the light intensity).

For example, light receivers (e.g., the second light receiver 402 and the fourth light receiver 404) disposed close to the second side surface 214 may first identify light reflected from the user's finger. After the light is identified in the light receivers disposed close to the second side surface 214, light receivers (e.g., the first light receiver 401 and the third light receiver 403) disposed far from the second side surface 214 may identify the light reflected from the user's finger.

Signals identified in the light receivers (e.g., the second light receiver 402 and the fourth light receiver 404) disposed close to the second side surface 214 may be saturated earlier than signals identified in the light receivers (e.g., the first light receiver 401 and the third light receiver 403) disposed far from the second side surface 214. The second signal identified through the second light receiver 402 and the fourth signal identified through the fourth light receiver 404 may be saturated at the timing 501. The first signal identified through the first light receiver 401 and the third signal identified through the third light receiver 403 may be saturated at a timing 502.

Referring to FIG. 6B, a graph 610 represents intensity of a first signal identified through the first light receiver 401 over time. A graph 620 represents intensity of a second signal identified through the second light receiver 402 over time. A graph 630 represents intensity of a third signal identified through the third light receiver 403 over time. A graph 640 represents intensity of a fourth signal identified through the fourth light receiver 404 over time.

A timing at which intensity of a signal becomes saturated according to wearing of the smart ring device 200 may be different for each of light receivers. For example, in a case that the smart ring device 200 is worn in the second direction, the first side surface 213 may approach the user's finger first.

For example, the processor 210 may identify an amount of change in the first signal (or a first value for light intensity) and an amount of change in the second signal (or a second value for light intensity) at a specified timing (e.g., a timing 601). At the specified timing (e.g., the timing 601), the amount of change in the first signal (or the first value for the light intensity) may be greater than or equal to the amount of change in the second signal (or the second value for the light intensity).

For example, light receivers (e.g., the first light receiver 401 and the third light receiver 403) disposed close to the first side surface 213 may first identify light reflected from the user's finger. After the light is identified in the light receivers disposed close to the first side surface 213, light receivers (e.g., the second light receiver 402 and the fourth light receiver 404) disposed far from the first side surface 213 may identify the light reflected from the user's finger.

Signals identified in the light receivers (e.g., the first light receiver 401 and the third light receiver 403) disposed close to the first side surface 213 may be saturated earlier than signals identified in the light receivers (e.g., the second light receiver 402 and the fourth light receiver 404) disposed far from the first side surface 213. The first signal identified through the first light receiver 401 and the third signal identified through the third light receiver 403 may be saturated at the timing 601. The second signal identified through the second light receiver 402 and the fourth signal identified through the fourth light receiver 404 may be saturated at a timing 602.

Referring to FIGS. 5A, 5B, 6A, and 6B, the processor 210 may identify the wearing direction of the smart ring device 200 as one of the first direction or the second direction based on an order in which light is identified by the plurality of light receivers (or an order in which a signal is saturated). The processor 210 may identify the wearing direction of the smart ring device 200 as the first direction based on the second light receiver 402 and the fourth light receiver 404 identifying light earlier than the first light receiver 401 and the third light receiver 403. The processor 210 may identify the wearing direction of the smart ring device 200 as the second direction based on the first light receiver 401 and the third light receiver 403 identifying light earlier than the second light receiver 402 and the fourth light receiver 404.

Referring to FIGS. 5A, 5B, 6A, and 6B, the processor 210 may identify the wearing direction of the smart ring device 200 as one of the first direction and the second direction based on the amount of change in the first signal (or the first value for the light intensity) and the amount of change in the second signal (or the second value for the light intensity). The processor 210 may identify the wearing direction of the smart ring device 200 as the first direction based on identifying that the amount of change in the first signal (or the first value for the light intensity) is less than the amount of change in the second signal (or the second value for the light intensity). The processor 210 may identify the wearing direction of the smart ring device 200 as the second direction based on identifying that the amount of change in the first signal (or the first value for the light intensity) is greater than or equal to the amount of change in the second signal (or the second value for the light intensity).

For example, based on the wearing direction of the smart ring device 200, the processor 210 may perform a function according to a user input (e.g., a rotation input or a touch input) generated in a state in which the smart ring device 200 is worn by the user.

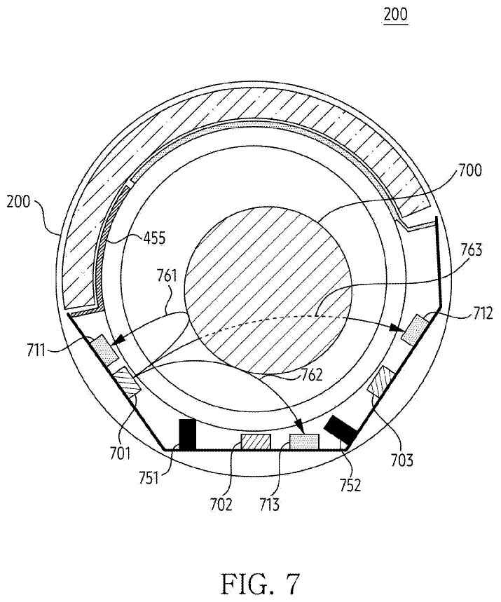

FIG. 7 illustrates a path of light emitted from a light emitter, according to an embodiment of the disclosure.

Referring to FIG. 7, a smart ring device 200 may include a light emitting circuit 701, a light emitting circuit 702, a light emitting circuit 703, a light receiving circuit 711, a light receiving circuit 712, and a light receiving circuit 713. Each of the light emitting circuit 701, the light emitting circuit 702, and the light emitting circuit 703 may emit light. The light emitted through the light emitting circuit 701, the light emitting circuit 702, and the light emitting circuit 703 may be reflected from a user's finger 700, and the reflected light may be identified through the light receiving circuit 711, the light receiving circuit 712, and the light receiving circuit 713. For example, the light emitting circuit 701, the light emitting circuit 702, and the light emitting circuit 703 may be an example of the one or more light emitting circuits 233-1 described in FIG. 2B. The light receiving circuit 711, the light receiving circuit 712, and the light receiving circuit 713 may be an example of the one or more light receiving circuits 233-2 described in FIG. 2B.

FIG. 7 illustrates movement paths of light emitted through a light emitting circuit for convenience of description. Although not illustrated, light emitted from the light emitting circuit 702 and the light emitting circuit 703 may move similarly to the movement paths of light emitted through the light emitting circuit 701 described below.

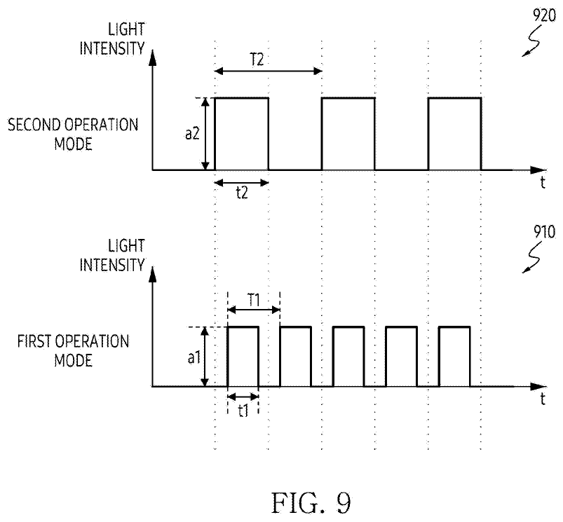

According to an embodiment of the disclosure, the light emitting circuit 701 may emit light. For example, the light emitting circuit 701 may emit light based on a specified time interval (or a specified period). The light receiving circuit 711, the light receiving circuit 712, or the light receiving circuit 713 may identify light based on a specified time interval (or a specified period). For example, a processor 210 may activate one or more light emitting circuits (e.g., the light emitting circuit 701, the light emitting circuit 702, and the light emitting circuit 703) and one or more light receiving circuits (e.g., the light receiving circuit 711, the light receiving circuit 712, and the light receiving circuit 713) based on a specified time interval (or a specified period). Since the one or more light emitting circuits and the one or more light receiving circuits are activated according to the specified time interval (or the specified period), current consumption may be minimized. According to an embodiment of the disclosure, the processor 210 may identify that the user is wearing the smart ring device 200, by using an acceleration sensor 231 and/or a gyro sensor 232. The processor 210 may operate in an operation mode for identifying a wearing direction of the smart ring device 200 based on identifying that the user is wearing the smart ring device 200. Based on the operation mode for identifying the wearing direction of the smart ring device 200, the processor 210 may activate the one or more light emitting circuits (e.g., the light emitting circuit 701, the light emitting circuit 702, and the light emitting circuit 703) and the one or more light receiving circuits (e.g., the light receiving circuit 711, the light receiving circuit 712, and the light receiving circuit 713), based on the specified time interval (or the specified period). For example, the operation mode for identifying the wearing direction of the smart ring device 200 may be distinguished from an operation mode for identifying information on the user (e.g., information on a blood flow amount). A specific example of an operation of the one or more light emitting circuits in each of the operation mode for identifying the wearing direction of the smart ring device 200 and the operation mode for identifying the information on the user (e.g., the information on the blood flow amount) will be described later in FIG. 9.

According to an embodiment of the disclosure, in a case that the smart ring device 200 is not worn on the user's finger, the light emitted through the light emitting circuit 701 may not be identified by the light receiving circuit 711, the light receiving circuit 712, or the light receiving circuit 713. In a case that the smart ring device 200 is not worn on the user's finger, a value representing intensity of light identified by the light receiving circuit 711, the light receiving circuit 712, or the light receiving circuit 713 may be less than a threshold value. The processor 210 may identify that the smart ring device 200 is not worn by the user based on identifying that the value representing the intensity of the light identified by the light receiving circuit 711, the light receiving circuit 712, or the light receiving circuit 713 is less than the threshold value.

In a case that the smart ring device 200 is worn on the user's finger 700, the light emitted through the light emitting circuit 701 may be identified by the light receiving circuit 711, the light receiving circuit 712, or the light receiving circuit 713. For example, the light emitted through the light emitting circuit 701 may be reflected from the user's finger 700. The light reflected from the user's finger 700 may be identified by the light receiving circuit 711 through a path 761. The light reflected from the user's finger 700 may be identified by the light receiving circuit 713 through a path 762. For example, the light emitted through the light emitting circuit 701 may transmit through the user's finger 700. The light transmitted through the user's finger 700 may be identified by the light receiving circuit 712 through a path 763.

The processor 210 may identify whether the smart ring device 200 is worn on the user's finger, based on signals identified by the light receiving circuit 711, the light receiving circuit 712, and the light receiving circuit 713. The processor 210 may identify the wearing direction of the smart ring device 200 based on the operations of FIGS. 5A, 5B, 6A, and 6B.

According to an embodiment of the disclosure, a light emitting circuit (e.g., the light emitting circuit 701) may be configured to emit light in an IR band. According to an embodiment of the disclosure, the light emitting circuit (e.g., the light emitting circuit 701) may be configured with a red LED and/or a green LED. The light emitting circuit may be configured to emit red and/or green light. According to an embodiment of the disclosure, the one or more light emitting circuits (e.g., the light emitting circuit 701, the light emitting circuit 702, and the light emitting circuit 703) included in the smart ring device 200 may be configured to emit at least one of the light in the IR band, red light, and/or green light.

According to an embodiment of the disclosure, at least a part of a first surface 211 of the smart ring device 200 may be transparently formed. For example, the smart ring device 200 may include one or more light emitting circuits (e.g., the light emitting circuit 701, the light emitting circuit 702, and the light emitting circuit 703) and two or more light receiving circuits (e.g., the light receiving circuit 711, the light receiving circuit 712, and the light receiving circuit 713). The one or more light emitting circuits (e.g., the light emitting circuit 701, the light emitting circuit 702, and the light emitting circuit 703) may include an element configured to emit light in one or more wavelength bands. For example, the one or more light emitting circuits (e.g., the light emitting circuit 701, the light emitting circuit 702, and the light emitting circuit 703) may include a light emitting circuit for emitting a wavelength related to red and a light emitting circuit for respectively emitting an IR wavelength. The wavelength related to red may be configured with a spectrum of 600 nano-meters [nm] to 650 [nm]. The IR wavelength may be configured with a spectrum of 850 [nm] to 900 [nm].

For example, the processor 210 may output light in each wavelength band based on time division. As an example, the processor 210 may emit light in the red wavelength through the light emitting circuit 701. In a case that the light in the red wavelength is emitted from the light emitting circuit 701, the light receiving circuit 713 may identify the light reflected from the finger 700 through the path 762. As an example, the light receiving circuit 712 may identify the light transmitted through the finger 700 through the path 763. As an example, the processor 210 may emit the light in the IR band through the light emitting circuit 701 based on time division. The processor 210 may emit light in the IR band of first intensity toward the light receiving circuit 712 through the light emitting circuit 701 at a first timing, and may emit light in the IR band of second intensity toward the light receiving circuit 712 through the light emitting circuit 701 at a second timing.

The processor 210 may identify, at the first timing, the light in the IR band emitted in the first intensity, by using the light receiving circuit 712. The light in the IR band emitted in the first intensity may be identified by the light receiving circuit 712 after transmitting through the user's finger 700. The processor 210 may identify, at the second timing, the light in the IR band emitted in the second intensity by using the light receiving circuit 713. The light in the IR band emitted in the second intensity may be identified by the light receiving circuit 713 after being reflected from the user's finger 700.

According to an embodiment of the disclosure, the smart ring device 200 may include a blocking member 751 and a blocking member 752. Since at least a part of a housing 201 (e.g., an inner housing portion 203) of the smart ring device 200 is formed transparently, light emitted from the one or more light emitting circuits 233-1 may be identified by the one or more light receiving circuits 233-2 by being transmitted and/or reflected inside the smart ring device 200. The blocking member 751 and the blocking member 752 may be disposed inside the smart ring device 200 to prevent the light emitted from the one or more light emitting circuits 233-1 from being identified by the one or more light receiving circuits 233-2 by being transmitted and/or reflected inside the smart ring device 200. The blocking member 751 and the blocking member 752 may be disposed inside the smart ring device 200 to prevent the light emitted from the one or more light emitting circuits 233-1 from being directly emitted to the one or more light receiving circuits 233-2.

For example, the blocking member 751 may be disposed between the light emitting circuit 701 and the light receiving circuit 713. The blocking member 751 may be disposed between the light emitting circuit 702 and the light receiving circuit 711. The blocking member 752 may be disposed between the light emitting circuit 702 and the light receiving circuit 712. The blocking member 752 may be disposed between the light emitting circuit 703 and the light receiving circuit 713.

According to an embodiment of the disclosure, sizes of the blocking member 751 and the blocking member 752 may be formed to be different. However, it is not limited thereto. According to an embodiment of the disclosure, materials configuring the blocking member 751 and the blocking member 752 may be different from each other. However, it is not limited thereto. According to an embodiment of the disclosure, a distance between the blocking member 751 and the light receiving circuit 713 may be different from a distance between the blocking member 752 and the light receiving circuit 712. However, it is not limited thereto. For example, the distance between the blocking member 751 and the light receiving circuit 713 may be shorter than the distance between the blocking member 752 and the light receiving circuit 712.

According to an embodiment of the disclosure, the smart ring device 200 may be configured in various sizes according to a size of the user's finger. A diameter of the smart ring device 200 may be configured in various lengths. Although sizes of components inside the smart ring device 200 are not changed, a distance between the components may be changed based on a size of the smart ring device 200. For example, the diameter of the smart ring device 200 may be set to one of 2 centimeters [cm] and 2.5 [cm]. A distance between a light emitting circuit and a light receiving circuit included in a smart ring device with a diameter of 2 [cm] may be shorter than a distance between a light emitting circuit and a light receiving circuit included in a smart ring device with a diameter of 2.5 [cm].

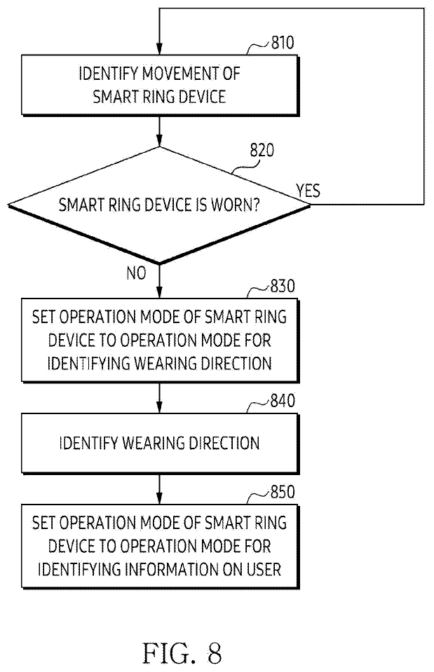

FIG. 8 illustrates a flowchart related to an operation of a smart ring device according to an embodiment of the disclosure.

In the following embodiment of the disclosure, each of operations may be sequentially performed, but is not necessarily performed sequentially. For example, an order of each of the operations may be changed, and at least two operations may be performed in parallel.

Referring to FIG. 8, in operation 810, a processor 210 of a smart ring device 200 may identify a movement of the smart ring device 200. For example, the processor 210 may identify the movement of the smart ring device 200 by using at least one of an acceleration sensor 231 and/or a gyro sensor 232. As an example, the processor 210 may identify that the movement of the smart ring device 200 has occurred based on identifying that a value representing acceleration of the smart ring device 200 identified through the acceleration sensor 231 is greater than a first threshold value. As an example, the processor 210 may identify that the movement of the smart ring device 200 has occurred based on identifying that a value representing angular velocity of the smart ring device 200 identified through the gyro sensor 232 is greater than a second threshold value.

In operation 820, the processor 210 may identify whether the smart ring device 200 is worn by a user. For example, the processor 210 may identify whether the smart ring device 200 is worn by the user, by using at least one of one or more light emitting circuits 233-1 and/or one or more light receiving circuits 233-2. For example, the processor 210 may identify whether the smart ring device 200 is worn by the user, based on a plurality of signals identified through a plurality of light receivers included in a light receiving circuit (e.g., the light receiving circuit 400 of FIG. 4).

According to an embodiment of the disclosure, in a case that the smart ring device 200 is worn by the user, the processor 210 may perform the operation 810 again. According to an embodiment of the disclosure, in a case that the smart ring device 200 is worn by the user, the smart ring device 200 may operate in an operation mode for identifying information on the user.

In operation 830, in a case that the smart ring device 200 is not worn by the user, the processor 210 may set an operation mode of the smart ring device 200 to an operation mode for identifying a wearing direction. For example, the processor 210 may set the operation mode of the smart ring device 200 as the operation mode for identifying the wearing direction based on identifying that the smart ring device 200 is not worn by the user. For example, in the operation mode for identifying the wearing direction, the processor 210 may emit light in an IR band using the one or more light emitting circuits 233-1. The processor 210 may identify the light in the IR band (or a part of the light in the IR band) by using the one or more light receiving circuits 233-2.

In operation 840, the processor 210 may identify (or determine) the wearing direction of the smart ring device 200. For example, the processor 210 may identify (or determine) the wearing direction of the smart ring device 200 based on signals identified using the one or more light receiving circuits 233-2.

For example, the processor 210 may identify the wearing direction of the smart ring device 200 as one of a first direction and a second direction. In a case that the smart ring device 200 is worn in the first direction, a direction in which a first side surface 213 of the smart ring device 200 faces may correspond to a direction in which a finger on which the smart ring device 200 is worn faces. In a case that the smart ring device 200 is worn in the second direction, a direction in which a second side surface 214 of the smart ring device 200 faces may correspond to a direction in which the finger on which the smart ring device 200 is worn faces. A specific operation for identifying the wearing direction of the smart ring device 200 may be referred to FIGS. 1, 2A to 2C, 3, 4, 5A, 5B, 6A, 6B, and 7.

In operation 850, the processor 210 may set the operation mode of the smart ring device 200 to the operation mode for identifying the information on the user. For example, the processor 210 may change the operation mode of the smart ring device 200 after the wearing direction of the smart ring device 200 is identified. Based on identifying the wearing direction of the smart ring device 200, the processor 210 may change the operation mode of the smart ring device 200 from the operation mode for identifying the wearing direction to the operation mode for identifying the information on the user. Based on identifying the wearing direction of the smart ring device 200, the processor 210 may set the operation mode of the smart ring device 200 as the operation mode for identifying the information on the user.

For example, in the operation mode for identifying the information on the user, the processor 210 may identify health information (e.g., heart rate measurement (HRM) information) of the user using a PPG sensor 233.

According to an embodiment of the disclosure, the processor 210 may distinguish the operation mode (hereinafter, a first operation mode) for identifying the wearing direction and the operation mode (hereinafter, a second operation mode) for identifying the information on the user. For example, in the first operation mode, the processor 210 may perform a first light emission (or a first light emission) through at least one of the one or more light emitting circuits 233-1. In the second operation mode, the processor 210 may perform a second light emission through at least one of the one or more light emitting circuits 233-1. The second light emission may be different from the first light emission in at least one of light intensity, emission time, or an emission period. As an example, the processor 210 may set light intensity according to the first light emission to be weaker than light intensity according to the second light emission. The processor 210 may efficiently use power by setting the light intensity according to the first light emission to be weaker than the light intensity according to the second light emission.

FIG. 9 illustrates intensity of light emitted based on an operation mode of a smart ring device according to an embodiment of the disclosure.

Referring to FIG. 9, a processor 210 may set at least one of intensity, a light wavelength, emission time (or emission duration), or an emission period of light emitted through at least one of one or more light emitting circuits 233-1. For example, the processor 210 may set at least one of intensity, a wavelength, emission time, or an emission period of light emitted through at least one of the one or more light emitting circuits 233-1, based on an operation mode of a smart ring device 200.

According to an embodiment of the disclosure, in an operation mode (hereinafter, a second operation mode) for identifying information on a user, the processor 210 may identify light transmitted or reflected from the user's finger. by using one or more light receiving circuits 233-2. Therefore, the processor 210 may set at least one of light intensity, a light wavelength, emission time, or an emission period based on a transmittance and/or a reflectance of light with respect to the user's finger.

On the other hand, in an operation mode (hereinafter, a first operation mode) for identifying a wearing direction, the processor 210 may first operate in a state in which the smart ring device 200 is not worn. Therefore, in the first operation mode, the processor 210 may adjust at least one of the light intensity, the light wavelength, the emission time, or the emission period set in the second operation mode. A graph 910 represents intensity of light emitted over time in the first operation mode. A graph 920 represents intensity of light emitted over time in the second operation mode.

For example, since a transmittance of air is higher than a transmittance of the user's finger, the processor 210 may set the intensity of the light emitted in the first operation mode to be less than the intensity of the light emitted in the second operation mode. Referring to the graph 910 and the graph 920, the intensity of the light emitted in the first operation mode may be a1. The intensity of the light emitted in the second operation mode may be a2. The a1 may be set to be less than the a2.

For example, the processor 210 may set emission time in the first operation mode to be shorter than emission time in the second operation mode. Referring to the graph 910 and the graph 920, the emission time in the first operation mode may be t1. The emission time in the second operation mode may be t2. The t1 may be set to be shorter than the t2.

For example, the processor 210 may set an emission period in the first operation mode to be shorter than an emission period in the second operation mode. Referring to the graph 910 and the graph 920, the emission period in the first operation mode may be set to T1 (e.g., 1/60 second). The emission period in the second operation mode may be set to T2 (e.g., 1/30 second). The T1 may be set to be shorter than the T2.

According to an embodiment of the disclosure, the processor 210 may improve accuracy of identification with respect to the wearing direction by setting the emission period to be short in the first operation mode. According to an embodiment of the disclosure, the processor 210 may set the intensity of the light emitted in the first operation mode to be greater than the intensity of the light emitted in the second operation mode, and set the emission time in the first operation mode to be shorter than the emission time in the second operation mode.

According to an embodiment of the disclosure, the processor 210 may change the number of light emitting circuits and/or the number of light receiving circuits to be activated, based on the operation mode of the smart ring device 200. For example, the processor 210 may set the number of light receiving circuits activated in the first operation mode differently from the number of light receiving circuits activated in the second operation mode. For example, the processor 210 may identify the information on the user by using all of the one or more light receiving circuits 233-2 in the second operation mode. The processor 210 may identify the wearing direction of the smart ring device 200 by using one of the one or more light receiving circuits 233-2 in the first operation mode.

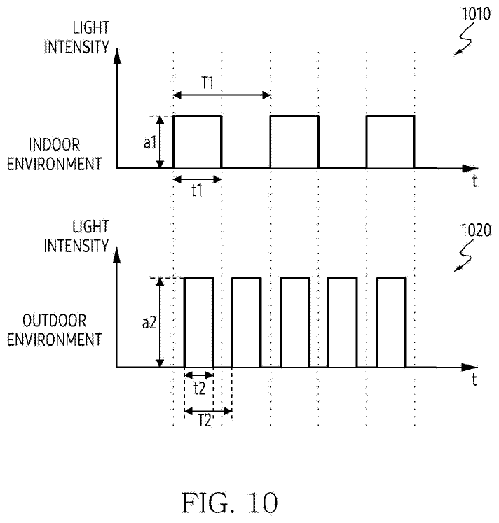

FIG. 10 illustrates intensity of light emitted based on a surrounding environment of a smart ring device according to an embodiment of the disclosure.

Referring to FIG. 10, a processor 210 may control an operation of one or more light emitting circuits 233-1 and/or one or more light receiving circuits 233-2 according to a surrounding environment (or a surrounding light source environment). A graph 1010 represents intensity of light emitted from at least one of the one or more light emitting circuits 233-1 over time while a smart ring device 200 (or a user) is positioned in an indoor environment. A graph 1020 represents intensity of light emitted from the one or more light emitting circuits 233-1 (or at least one of the one or more light emitting circuits 233-1) over time while the smart ring device 200 (or the user) is positioned in an outdoor environment.

For example, the processor 210 may set light intensity in the indoor environment to be less than light intensity in the outdoor environment. Referring to the graph 1010 and the graph 1020, the light intensity in the indoor environment may be a1. The light intensity in the outdoor environment may be a2. The a1 may be set to be less than the a2.

For example, the processor 210 may set emission time in the indoor environment to be longer than emission time in the outdoor environment. Referring to the graph 1010 and the graph 1020, the emission time in the indoor environment may be t1. The emission time in the outdoor environment may be t2. The t1 may be set to be longer than the t2.

For example, the processor 210 may set an emission period in the indoor environment to be longer than an emission period in the outdoor environment. Referring to the graph 1010 and the graph 1020, the emission period in the indoor environment may be T1 (e.g., 1/30 second). The emission period in the outdoor environment may be T2 (e.g., 1/60 second). The T1 may be set to be longer than the T2.

For example, in a case that the smart ring device 200 (or the user) is positioned in the indoor environment, illuminance of the indoor environment may be lower than illuminance of the outdoor environment. Therefore, the smart ring device 200 may be less affected by ambient light in the indoor environment. As an example, in a case that the user wears the smart ring device 200 in an environment with strong infrared radiation, such as sundown, one or more light receiving circuits may identify external infrared radiation. Therefore, noise may be generated by the external infrared radiation. Therefore, the processor 310 may set the light intensity in the outdoor environment to be greater than the light intensity in the indoor environment.

According to an embodiment of the disclosure, in an operation mode (hereinafter, a first operation mode) for identifying a wearing direction, the processor 210 may not first emit light using the one or more light emitting circuits 233-1. The processor 210 may identify an infrared component of ambient light before emitting light using the one or more light emitting circuits 233-1. Based on identifying that intensity of the infrared component of the ambient light is greater than a threshold value, the processor 210 may increase intensity of infrared radiation (or light) emitted through the one or more light emitting circuits 233-1. According to an embodiment of the disclosure, since power consumption increases in a case that the intensity of the emitted infrared radiation (or light) is increased, the processor 210 may set emission time to be shorter than emission time in a case that the intensity of the infrared component of the ambient light is not greater than the threshold value.

According to an embodiment of the disclosure, based on identifying that the intensity of the infrared component of the ambient light is greater than the threshold value, the processor 210 may set an emission period to be shorter than an emission period in a case that the intensity of the infrared component of the ambient light is not greater than the threshold value. The processor 210 may improve accuracy with respect to identification of the wearing direction by setting the emission period to be shorter than the emission period in a case that the intensity of the infrared component of the ambient light is not greater than the threshold value.

According to an embodiment of the disclosure, the processor 210 may change sensitivity of the one or more light receiving circuits 233-2 based on the surrounding environment. For example, in a case that illuminance of the surrounding environment is high, the processor 210 may reduce the sensitivity of the one or more light receiving circuits 233-2. In a case that the illuminance of the surrounding environment is low, the processor 210 may increase the sensitivity of the one or more light receiving circuits 233-2.

According to an embodiment of the disclosure, the processor 210 may change a threshold value for identifying the wearing direction based on the surrounding environment. For example, in a case that the intensity of the infrared component of the ambient light is large, the processor 210 may increase the threshold value for identifying wearing detection (or the wearing direction) by using signals of the one or more light receiving circuits 233-2. For example, the processor 210 may detect the wearing of the smart ring device 200 based on identifying that intensity of light identified through the one or more light receiving circuits 233-2 is greater than or equal to the threshold value. Since the infrared component of the ambient light is also identified through the one or more light receiving circuits 233-2, the processor 210 may set the threshold value to be high.

According to an embodiment of the disclosure, the processor 210 may set at least one of intensity, a wavelength, emission time (or emission duration), or an emission period of light emitted through at least one of the one or more light emitting circuits 233-1 based on a characteristic of the user's finger. For example, an amount of reflected light in a case that a skin color of the user's finger is dark may be less than an amount of reflected light in a case that the skin color of the user's finger is light. Therefore, the processor 210 may obtain information on the skin color of the user by using the smart ring device 200 or an external electronic device 300 connected to the smart ring device 200. In a case that the skin color of the user's finger is darker than a skin color of average users, the processor 210 may increase the intensity of the light emitted through at least one of the one or more light emitting circuits 233-1.

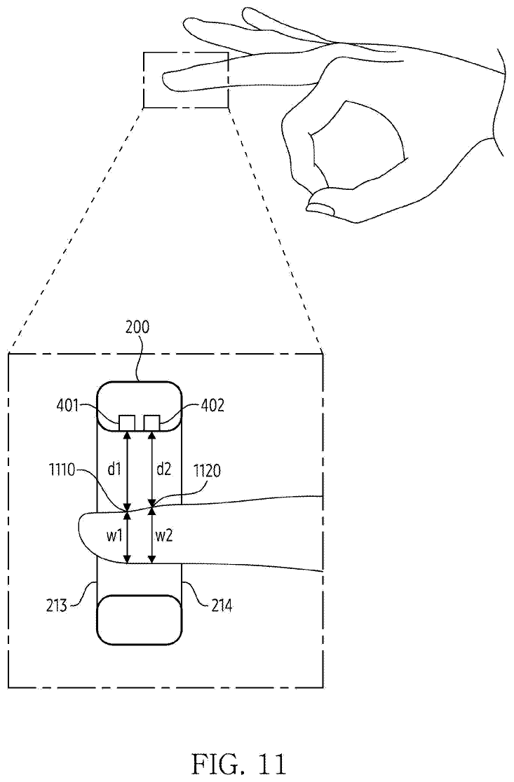

FIG. 11 illustrates an operation of a smart ring device for identifying a wearing direction of the smart ring device according to an embodiment of the disclosure.

Referring to FIG. 11, a processor 210 may identify a wearing direction of a smart ring device 200 based on a distance from a part of a finger identified in each of a plurality of receivers (e.g., a first light receiver 401 and a second light receiver 402). A thickness of the user's finger may become thicker from a fingernail to a dorsum of a hand. Therefore, when the smart ring device 200 is worn, intensity of light identified by the first light receiver 401 and the second light receiver 402 may be different from each other.

For example, a second side surface 214 may approach the finger earlier than a first side surface 213. The first light receiver 401 disposed close to the first side surface 213 may identify light reflected from a first part 1110 of the finger. The second light receiver 402 disposed close to the second side surface 214 may identify light reflected from a second part 1120 of the finger. A thickness of the first part 1110 of the finger may be w1. A thickness of the second part 1120 of the finger may be w2. A distance d1 from the first light receiver 401 to the first part 1110 of the finger may be longer than a distance d2 from the second light receiver 402 to the second part 1120 of the finger. Therefore, at a specified timing (e.g., a timing within a time period in which the smart ring device 200 is worn), intensity of light reflected from the first part 1110 of the finger and identified by the first light receiver 401 may be less than intensity of light reflected from the second part 1120 of the finger and identified by the second light receiver 402. The processor 210 may identify that the smart ring device 200 is worn in a first direction based on identifying that the intensity of the light identified by the first light receiver 401 is less than the intensity of the light identified by the second light receiver 402. Similar to the above-described example, the processor 210 may identify that the smart ring device 200 is worn in a second direction based on identifying that the intensity of the light identified by the first light receiver 401 is greater than or equal to the intensity of the light identified by the second light receiver 402 at a specified timing.

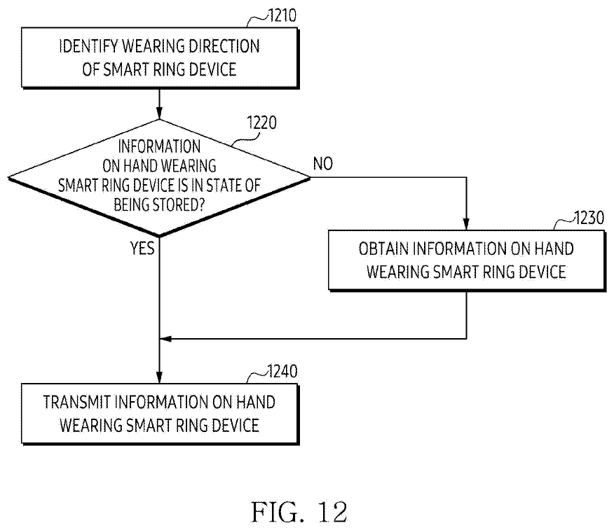

FIG. 12 illustrates a flowchart related to an operation of a smart ring device according to an embodiment of the disclosure.

Referring to FIG. 12, each of operations may be sequentially performed, but is not necessarily performed sequentially. For example, an order of each of the operations may be changed, and at least two operations may be performed in parallel.

In operation 1210, a processor 210 may identify a wearing direction of a smart ring device 200. For example, the operation 1210 may correspond to the operation 840 of FIG. 8.

In operation 1220, the processor 210 may identify whether information on a hand wearing the smart ring device 200 is in a state of being stored in memory 240. For example, based on identifying the wearing direction of the smart ring device 200, the processor 210 may identify whether the information on the hand wearing the smart ring device 200 is in a state of being stored in the memory 240.

For example, the processor 210 may identify whether information on a hand mainly wearing the smart ring device 200 is in a state of being stored in the memory 240. In a case that the information on the mainly worn hand is stored in the memory 240, the processor 210 may identify the information on the hand wearing the smart ring device 200.

In operation 1230, in a case that the information on the hand wearing the smart ring device 200 is not stored in the memory 240, the processor 210 may obtain the information on the hand wearing the smart ring device 200. The processor 210 may obtain the information on the hand wearing the smart ring device 200 based on identifying that the information on the hand wearing the smart ring device 200 is not stored in the memory 240.

According to an embodiment of the disclosure, the processor 210 may identify an input for obtaining the information on the hand wearing the smart ring device 200. For example, the processor 210 may request the information on the hand wearing the smart ring device 200. The processor 210 may identify the input for obtaining the information on the hand wearing the smart ring device 200 by using the smart ring device 200 or an external electronic device 300 connected to the smart ring device 200.

According to an embodiment of the disclosure, in a case that the processor 210 is in a state in which a wearable device distinct from the smart ring device 200 is worn on a hand (e.g., a wrist), the processor 210 may compare a value for acceleration identified by the wearable device with a value for acceleration identified by the smart ring device 200. The processor 210 may identify the hand wearing the smart ring device 200, based on the comparison. For example, the processor 210 may receive information on the hand wearing the wearable device from the wearable device or an external electronic device (e.g., a smartphone) communicatively connected to the wearable device. The information on the hand wearing the wearable device may be in a state of being stored in the memory 240 of the smart ring device 200. For example, in a case that the wearable device is worn on a right hand, the processor 210 may identify that the smart ring device 200 is worn on the right hand, based on identifying that the value for the acceleration identified by the wearable device corresponds to the value for the acceleration identified by the smart ring device 200. For example, in a case that the wearable device is worn on the right hand, the processor 210 may identify that the smart ring device 200 is worn on a left hand, based on identifying that the value for the acceleration identified by the wearable device is distinct from the value for the acceleration identified by the smart ring device 200.

According to an embodiment of the disclosure, in a case that the wearable device distinct from the smart ring device 200 is in a state of being worn on a hand (e.g., a wrist), the processor 210 may compare a waveform with respect to a heart rate identified by the wearable device with a waveform with respect to a heart rate identified by the smart ring device 200. The processor 210 may identify the hand wearing the smart ring device 200, based on the comparison.

According to an embodiment of the disclosure, the processor 210 may store the information on the hand wearing the smart ring device 200 in the memory 240, based on obtaining the information on the hand wearing the smart ring device 200.

In operation 1240, the processor 210 may transmit, to the external electronic device 300, the information on the hand wearing the smart ring device 200. The processor 210 may transmit, to the external electronic device 300, the information on the hand wearing the smart ring device 200 and information on a rotation input of the smart ring device 200. For example, the external electronic device 300 may perform a function according to the rotation input based on the information on the hand wearing the smart ring device 200 and the information on the rotation input of the smart ring device 200. For example, in a case that the smart ring device 200 is worn on the left hand, a first function may be performed based on the information on the rotation input of the smart ring device 200. For example, in a case that the smart ring device 200 is worn on the right hand, a second function distinct from the first function may be performed based on the information on the rotation input of the smart ring device 200.

According to an embodiment of the disclosure, the processor 210 may generate a control signal that causes the external electronic device 300 to perform a function, based on the information on the hand wearing the smart ring device 200 and the information on the rotation input of the smart ring device 200. The processor 210 may transmit the generated control signal to the external electronic device 300.

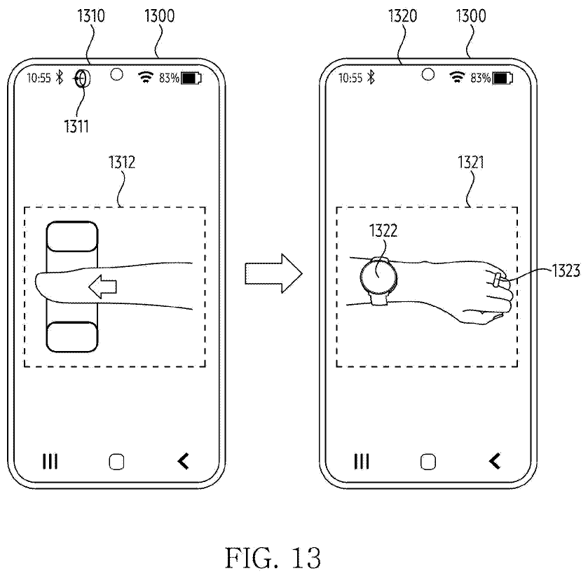

FIG. 13 illustrates a screen representing a wearing direction of a smart ring device according to an embodiment of the disclosure.

Referring to FIG. 13, a smart ring device 200 may be in a state of being connected with an external electronic device 1300 including a display. A processor 210 of the smart ring device 200 may identify that the smart ring device 200 is worn by a user. The processor 210 may identify a wearing direction of the smart ring device 200.

The processor 210 may transmit, to the external electronic device 1300, information on the wearing direction of the smart ring device 200. The external electronic device 1300 may receive, from the smart ring device 200, the information on the wearing direction of the smart ring device 200. Based on the information on the wearing direction of the smart ring device 200, the external electronic device 1300 may display, through the display of the external electronic device 1300, a screen 1310 representing the wearing of the smart ring device 200.

The screen 1310 may include a visual object 1312 representing the wearing (or the wearing direction) of the smart ring device 200. Although not illustrated, the screen 1310 may further include text for representing the wearing direction of the smart ring device 200 or the wearing (or the wearing direction) of the smart ring device 200. The external electronic device 1300 may display, through the display, a status bar representing an overall state of the external electronic device 1300. In the status bar, the external electronic device 1300 may display a visual object 1311 representing that the smart ring device 200 is worn.

After the screen 1310 is displayed, the external electronic device 1300 may identify wearable devices worn on the user's body. The external electronic device 1300 may display a screen 1320 for representing the wearable devices worn on the user's body. For example, in a case that the user is in a state of wearing a watch-shaped wearable device and the smart ring device 200 on one hand, the screen 1320 may include a visual object 1321 representing the hand (or a wrist) on which the watch-shaped wearable device and the smart ring device 200 are worn. The visual object 1321 may include a visual object 1322 for representing the watch-shaped wearable device and a visual object 1323 for representing the smart ring device 200. Although not illustrated, the screen 1320 may further include text representing a list of the wearable devices worn by the user.

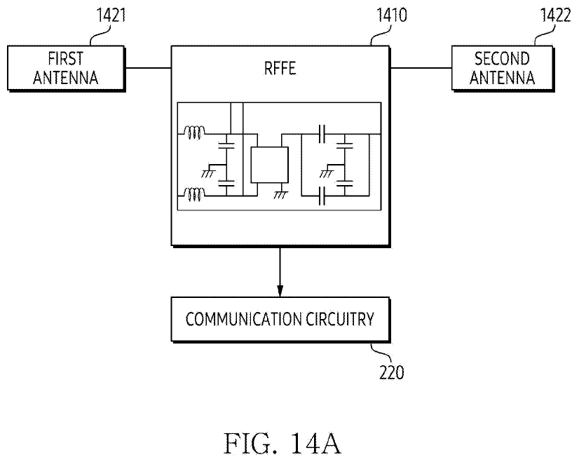

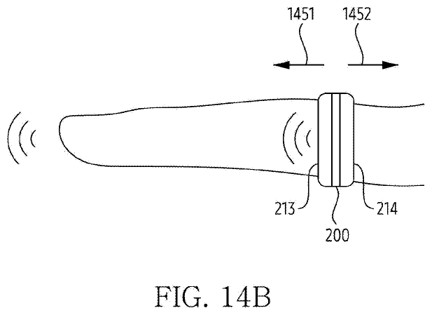

FIG. 14A illustrates circuitry including a plurality of antennas for changing a direction of a radiated signal according to an embodiment of the disclosure.

FIG. 14B illustrates a signal radiated from a smart ring device according to an embodiment of the disclosure.

Referring to FIGS. 14A and 14B, a smart ring device 200 may include communication circuitry 220, a radio frequency front end (RFFE) 1410, a first antenna 1421, and a second antenna 1422. The communication circuitry 220 may be connected to the RFFE 1410. By controlling the RFFE 1410, the communication circuitry 220 may radiate a signal using at least one of the first antenna 1421 and/or the second antenna 1422.

For example, the first antenna 1421 may be formed (or disposed) to radiate a signal in a direction 1451 in which a first side surface 213 faces. The second antenna 1422 may be formed (or disposed) to radiate a signal in a direction 1452 in which a second side surface 214 faces. For example, a housing 201 of the smart ring device 200 may be formed of metal. Therefore, the first antenna 1421 and the second antenna 1422 may be configured using at least a part (e.g., a segmented part) of the housing 201 of the smart ring device 200.

According to an embodiment of the disclosure, the communication circuitry 220 may include a near field communication (NFC) IC. The communication circuitry 220 may radiate an NFC signal through at least one of the first antenna 1421 and/or the second antenna 1422.

A processor 210 may identify a wearing direction of the smart ring device 200. The processor 210 may identify a surface facing a fingertip (or a nail) of a finger in a state in which the smart ring device 200 is worn as one of the first side surface 213 and the second side surface 214. As illustrated in FIG. 14B, the processor 210 may radiate an NFC signal through the first antenna 1421 based on identifying that the first side surface 213 faces the fingertip (or the nail) of the finger. The NFC signal radiated through the first antenna 1421 may be radiated in the direction 1451. For example, the NFC signal may be used for payment. A user of the smart ring device 200 may perform payment for a product by raising the finger on which the smart ring device 200 is worn and transmitting the NFC signal to an external electronic device for payment. The processor 210 may radiate the NFC signal based on identifying that the user's finger faces the external electronic device for payment.

As an example, in a state in which the smart ring device 200 is worn in a first direction, the processor 210 may radiate the NFC signal through the first antenna 1421 based on identifying that the user's finger faces the external electronic device for payment. As an example, in a state in which the smart ring device 200 is worn in a second direction, the processor 210 may radiate the NFC signal through the second antenna 1422 based on identifying that the user's finger faces the external electronic device for payment.

Although not illustrated, the smart ring device 200 may include a plurality of antennas including the first antenna 1421 and the second antenna 1422. Each of the plurality of antennas may be used for different radio access technologies (RATs) (e.g., NFC, Bluetooth communication, cellular communication, or wireless LAN communication). The plurality of antennas may be selectively used based on the wearing direction of the smart ring device 200. For example, in a case that the first antenna 1421 faces the fingertip of the finger and the second antenna 1422 faces a wrist, the processor 210 may use the first antenna 1421 for NCF communication and/or cellular communication, and may use the second antenna 1422 for Bluetooth communication and/or wireless LAN communication for a connection with a watch-shaped wearable device worn on the wrist or an external electronic device (e.g., a smartphone).

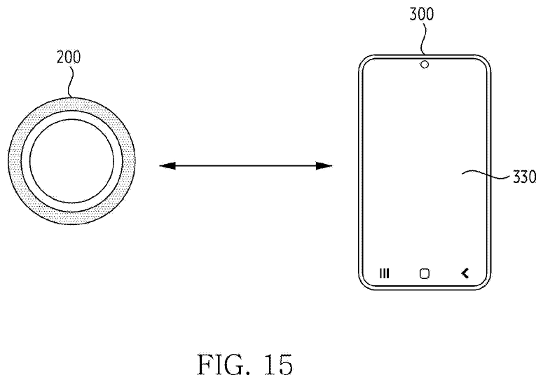

FIG. 15 illustrates an example in which a smart ring device is connected to an external electronic device according to an embodiment of the disclosure.

Referring to FIG. 15, a smart ring device 200 may be connected to an external electronic device 300. For example, the smart ring device 200 may be connected to the external electronic device 300 using a short-range wireless communication technique. For example, the smart ring device 200 may be fastened to the external electronic device 300 through a physical structure. Although not illustrated, the external electronic device 300 may include the physical structure for fastening the smart ring device 200. Although FIG. 15 illustrates that the external electronic device 300 has a shape of a smartphone, but is not limited thereto. The external electronic device 300 may include a device configured in various shapes. For example, the external electronic device 300 may include a wearable device, a smart watch, or a wireless earphone for providing augmented reality (AR) and/or virtual reality (VR).

Based on at least one of the above-described connection methods, the smart ring device 200 may establish a connection with the external electronic device 300. In a state in which the smart ring device 200 and the external electronic device 300 are connected, the smart ring device 200 (or a processor 210 of the smart ring device 200) may transmit information on a rotation input to the external electronic device 300 through communication circuitry 220. The external electronic device 300 (or a processor 310 of the external electronic device 300) may perform an operation mapped to the rotation input based on the information on the rotation input. For example, based on the rotation input, the external electronic device 300 may control a screen displayed through a display of the external electronic device 300.

According to an embodiment of the disclosure, when transmitting the information on the rotation input to the external electronic device 300, the smart ring device 200 may transmit information on a wearing direction of the smart ring device 200 together. According to an embodiment of the disclosure, the smart ring device 200 may generate a control signal according to the rotation input based on the wearing direction of the smart ring device 200. The smart ring device 200 may transmit the control signal to the external electronic device 300.

According to an embodiment of the disclosure, the smart ring device 200 may set a function of the external electronic device 300 mapped to the rotation input of the smart ring device 200 based on establishing the connection with the external electronic device 300. For example, the smart ring device 200 may identify capability information of the external electronic device 300 when establishing the connection with the external electronic device 300. The smart ring device 200 may obtain information on at least one of a form (or a shape) of the external electronic device 300, an application requiring control, a screen size, and a service type. Based on the information on at least one of the form (or the shape) of the external electronic device 300, the application requiring control, the screen size, and the service type, the smart ring device 200 may set the function of the external electronic device 300 mapped to the rotation input. The above-described operation may be performed by the processor 310 of the external electronic device 300 or by a processor of another external electronic device connected to the smart ring device 200 and the external electronic device 300. As an example, in a case that the external electronic device 300 has a watch shape, the another external electronic device (e.g., a smartphone) may perform a role as a primary device (or a master processor). The another external electronic device may identify the capability information of the external electronic device 300 and set the function of the external electronic device 300 mapped to the rotation input. Hereinafter, an example in which an operation of the smart ring device 200 and the external electronic device 300 is controlled through the another external electronic device will be described.

According to an embodiment of the disclosure, the another external electronic device may control the smart ring device 200 and the external electronic device 300. A processor of the another external electronic device may be referred to as a first processor. The processor 310 of the external electronic device 300 may be referred to as a second processor. For example, the second processor may perform a command according to a determination and a control operation of the first processor. According to an embodiment of the disclosure, the first processor and the second processor, which are in a state of being included in the same physical device, may be logically distinguished.

For example, the smart ring device 200 may establish the connection with the external electronic device 300. The smart ring device 200 may transmit, to the external electronic device 300, information obtained through a sensor 230 of the smart ring device 200. In a case that the smart ring device 200 transmits, to the external electronic device 300 (or the second processor), the information obtained through the sensor 230 of the smart ring device 200, and the external electronic device 300 processes the received information, battery consumption of the smart ring device 200 may be reduced. According to an embodiment of the disclosure, the smart ring device 200 may perform processing of the information obtained through the sensor 230, and transmit the processed information to the external electronic device 300.

As described above, when the connection between the smart ring device 200 and the external electronic device 300 (or the second processor) is completed, the information obtained through the sensor 230 of the smart ring device 200 may be transmitted to the external electronic device 300. When a connection with the another external electronic device is completed, the external electronic device 300 may notify the another external electronic device that the information obtained through the sensor 230 of the smart ring device 200 is being received.

The another external electronic device (or the first processor) may identify the capability information of the external electronic device 300 (or the second processor) (e.g., the information on at least one of the form (or the shape) of the external electronic device 300, the application requiring control, the screen size, and the service type), and functional information of the external electronic device 300. The smart ring device 200 may determine input value resolution according to the rotation input of the smart ring device 200 based on the capability information of the external electronic device 300 and the functional information of the external electronic device 300. For example, the input value resolution may mean a ratio of an input value that is changed in correspondence with an amount of change in a sensor value of the smart ring device 200 in the external electronic device 300.

For example, the external electronic device 300 may control scrolling of a screen displayed through a display 330 of the external electronic device 300 based on a sensor value for the rotation input of the smart ring device 200. As an example, the external electronic device 300 may receive a sensor value representing that a structure 215 of the smart ring device 200 rotates by 180 degrees. The external electronic device 300 may set the screen to be scrolled according to a ratio corresponding to one page, based on the sensor value. In a case that the external electronic device 300 receives a sensor value representing that the structure 215 of the smart ring device 200 rotates by 90 degrees, the external electronic device 300 may scroll the screen according to a ratio corresponding to a half page, based on the sensor value.

For example, in a case that 100 icons are included in an application list, the external electronic device 300 may set an indication to be switched to a next icon whenever the structure 215 of the smart ring device 200 rotates by 5 degrees. In a case that the structure 215 of the smart ring device 200 is rotated by 50 degrees, the external electronic device 300 may provide a user interface in which an indication of 10 icons is switched.

For example, the external electronic device 300 may provide a video editor function. The external electronic device 300 may scroll a video frame based on the rotation input of the smart ring device 200. The external electronic device 300 may set to display a main frame (e.g., an I frame or a frame including a main object of interest) according to the rotation input of the smart ring device 200. As switching all frames of a video according to a rotation angle of the structure 215 may cause inconvenience to the user, main frames may be switched based on a rotation angle range of the structure 215 of the smart ring device 200. As an example, in a case that the rotation angle range of the structure 215 of the smart ring device 200 is 0 to 5 degrees, the external electronic device 300 may set a first I frame to be displayed. Therefore, I frames may be switched based on a specified rotation angle range.

For example, the external electronic device 300 may control scrolling of the screen displayed through the display 330 of the external electronic device 300 based on rotation speed of the structure 215 of the smart ring device 200. As an example, scrolling speed of the screen may be set according to the rotation speed of the structure 215 of the smart ring device 200. For example, the external electronic device 300 may set speed at which an indication of icons is switched, based on the rotation speed of the structure 215 of the smart ring device 200.

According to an embodiment of the disclosure, the another external electronic device (or the first processor) may determine input value resolution of the external electronic device 300 (or the second processor). For example, the another external electronic device (or the first processor) may determine the input value resolution of the external electronic device 300 (or the second processor) based on at least one of a possible input value range, the number of scrolling target items (e.g., icons), or a range input value.

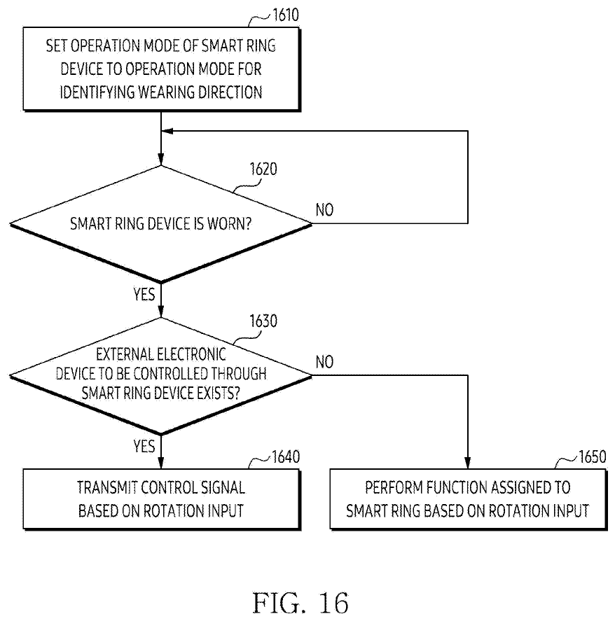

FIG. 16 illustrates a flowchart related to an operation of a smart ring device according to an embodiment of the disclosure.

In the following embodiment of the disclosure, each of operations may be sequentially performed, but is not necessarily performed sequentially. For example, an order of each of the operations may be changed, and at least two operations may be performed in parallel.

Referring to FIG. 16, in operation 1610, a processor 210 of a smart ring device 200 may set an operation mode of the smart ring device 200 to an operation mode for identifying a wearing direction of the smart ring device 200.

In operation 1620, the processor 210 may identify whether the smart ring device 200 is worn. For example, the processor 210 may identify whether the smart ring device 200 is worn in the operation mode for identifying the wearing direction of the smart ring device 200.

For example, the processor 210 may identify whether the smart ring device 200 is worn, by using a PPG sensor 233 (or a light receiving circuit 400). The processor 210 may identify the wearing direction of the smart ring device 200 using the PPG sensor 233 (or the light receiving circuit 400).

According to an embodiment of the disclosure, in a case that the smart ring device 200 is not worn, the operation 1620 may be performed based on a specified time period.

In operation 1630, in a case that the smart ring device 200 is worn, the processor 210 may identify whether an external electronic device 300 to be controlled through the smart ring device 200 exists. For example, the processor 210 may identify whether the external electronic device 300 to be controlled through the smart ring device 200 exists, based on identifying that the smart ring device 200 is worn by a user.

In operation 1640, in a case that the external electronic device 300 to be controlled through the smart ring device 200 exists, the processor 210 may transmit a control signal to the external electronic device 300 based on a rotation input. The processor 210 may identify the rotation input. As an example, the rotation input may be identified based on rotation of a structure 215 of the smart ring device 200. As an example, the rotation input may be identified based on a touch input maintained along a specified direction on a housing 201 of the smart ring device 200.

According to an embodiment of the disclosure, the processor 210 may identify a function of the external electronic device 300 mapped to the rotation input. The processor 210 may transmit the control signal to the external electronic device 300 to perform the function of the external electronic device 300 mapped to the rotation input. For example, the processor 210 may identify the function of the external electronic device 300 mapped to the rotation input based on the wearing direction of the smart ring device 200. The processor 210 may transmit, to the external electronic device 300, the control signal for controlling the external electronic device 300 to perform the identified function.

According to an embodiment of the disclosure, the processor 210 may transmit, to the external electronic device 300, information on the wearing direction of the smart ring device 200 and information on the rotation input. The external electronic device 300 may identify the function of the external electronic device 300 corresponding to the rotation input based on the information on the wearing direction of the smart ring device 200. The external electronic device 300 may perform the identified function.

In operation 1650, in a case that the external electronic device 300 to be controlled through the smart ring device 200 does not exist, the processor 210 may perform a function assigned to the smart ring device 200 based on the rotation input.

According to an embodiment of the disclosure, the processor 210 may identify a function of the smart ring device 200 mapped to the rotation input. The processor 210 may perform the identified function based on the rotation input.

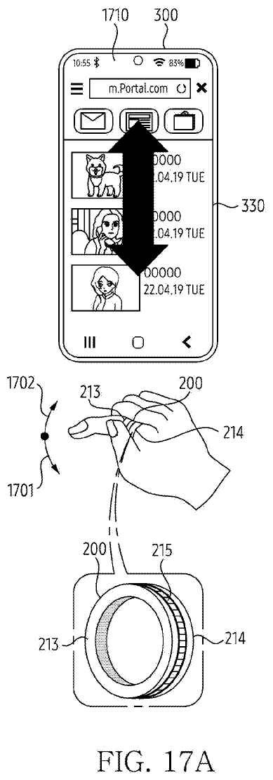

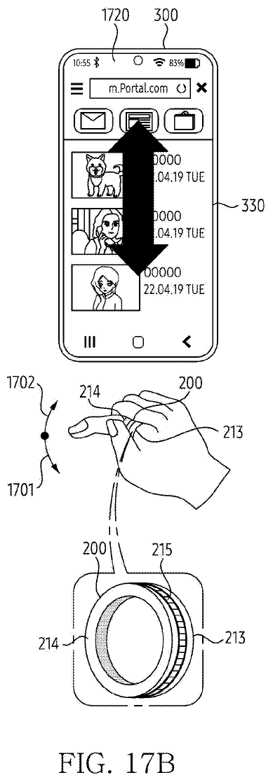

FIG. 17A illustrates a scroll input through a smart ring device according to an embodiment of the disclosure.

FIG. 17B illustrates a scroll input through a smart ring device according to an embodiment of the disclosure.

Referring to FIGS. 17A and 17B, a smart ring device 200 may be connected to an external electronic device 300 including a display 330. Based on a rotation input of the smart ring device 200, a screen (e.g., a screen 1710 or a screen 1720) displayed on the display 330 of the external electronic device 300 may be scrolled. For example, the rotation input may be identified based on rotation with respect to a structure 215 of the smart ring device 200, For example, the rotation input may be identified based on a touch input maintained along a specified direction on a housing 201 of the smart ring device 200.

Referring to FIG. 17A, the smart ring device 200 may be worn in a first direction. For example, in a state of being worn in the first direction, the smart ring device 200 may identify a rotation input. For example, a direction in which a first side surface 213 of the smart ring device 200 faces may face a nail of a finger on which the smart ring device 200 is worn.

For example, in a state in which the smart ring device 200 is worn in the first direction, a rotation input may be identified based on a direction 1701. A processor 210 may identify a function of the external electronic device 300 according to the identified rotation input based on a wearing direction of the smart ring device 200. The processor 210 may set the function of the external electronic device 300 according to the identified rotation input to a scroll down function of the screen 1710. However, it is not limited thereto.

For example, in a state in which the smart ring device 200 is worn in the first direction, a rotation input may be identified based on a direction 1702. The processor 210 may identify a function of the external electronic device 300 according to the identified rotation input based on the wearing direction of the smart ring device 200, The processor 210 may set the function of the external electronic device 300 according to the identified rotation input to a scroll up function of the screen 1710. However, it is not limited thereto.

Referring to FIG. 17B, the smart ring device 200 may be worn in a second direction. For example, in a state of being worn in the second direction, the smart ring device 200 may identify a rotation input. A direction in which a second side surface 214 of the smart ring device 200 faces may face the nail of the finger on which the smart ring device 200 is worn.

For example, in a state in which the smart ring device 200 is worn in the second direction, a rotation input may be identified based on the direction 1701. The processor 210 may identify a function of the external electronic device 300 according to the identified rotation input based on the wearing direction of the smart ring device 200. The processor 210 may set the function of the external electronic device 300 according to the identified rotation input to a scroll down function of the screen 1720. However, it is not limited thereto.

For example, in a state in which the smart ring device 200 is worn in the second direction, a rotation input may be identified based on the direction 1702. The processor 210 may identify a function of the external electronic device 300 according to the identified rotation input based on the wearing direction of the smart ring device 200. The processor 210 may set the function of the external electronic device 300 according to the identified rotation input to a scroll up function of the screen 1720. However, it is not limited thereto.

Referring to FIGS. 17A and 17B, even when directions of the rotation input are opposite to each other according to the wearing direction of the smart ring device 200, the processor 210 may transmit, to the external electronic device 300, information on a rotation input changed based on the wearing direction of the smart ring device 200. Therefore, even when the smart ring device 200 is worn in any direction, the external electronic device 300 may perform the same function in response to a rotation input according to the same gesture of the user.

Although not illustrated, the processor 210 may determine (or identify) a posture using an acceleration sensor 231 of the smart ring device 200. The processor 210 may determine (or set) a scroll direction based on the posture of the smart ring device 200. For example, based on identifying that the posture of the smart ring device 200 is a first posture, up or down scrolling may be performed according to a rotation input. For example, based on identifying that the posture of the smart ring device 200 is a second posture, left or right scrolling may be performed according to a rotation input.

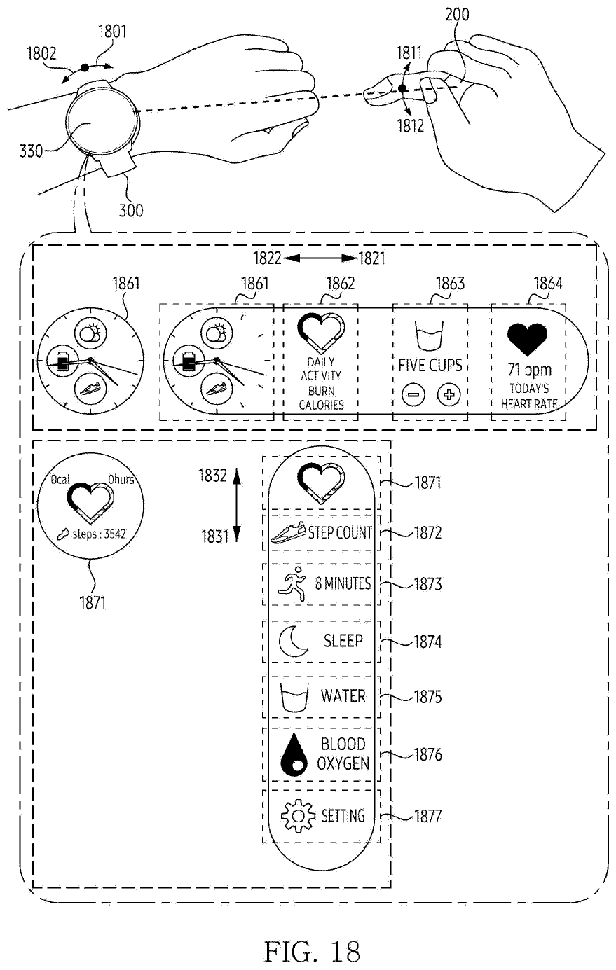

FIG. 18 illustrates a rotation input through a smart ring device according to an embodiment of the disclosure.

Referring to FIG. 18, a smart ring device 200 may identify a rotation input. For example, the smart ring device 200 may identify a first rotation input based on one of a direction 1811 and a direction 1812. For example, the first rotation input may be identified based on rotation of a structure 215 along one of the direction 1811 and the direction 1812. For example, the first rotation input may be identified based on a touch input maintained along one of the direction 1811 and the direction 1812. For example, the direction 1811 may be referred to as clockwise. The direction 1812 may be referred to as counterclockwise.

The smart ring device 200 may be in a state of being connected with an external electronic device 300. The external electronic device 300 may be configured in a watch shape. The external electronic device 300 may include a wheel key rotatable along a circular display 330. The wheel key may rotate in one of a direction 1801 and a direction 1802. Based on the rotation of the wheel key along one of the direction 1801 and the direction 1802, a second rotation input may be identified. For example, the direction 1801 may be referred to as clockwise. The direction 1802 may be referred to as counterclockwise.

For example, the first rotation input along the direction 1811 may correspond to the second rotation input along the direction 1801. A function of the external electronic device 300 performed based on the first rotation input along the direction 1811 may correspond to a function of the external electronic device 300 performed based on the second rotation input along the direction 1801. The function of the external electronic device 300 performed based on the first rotation input along the direction 1811 and/or the second rotation input along the direction 1801 may be set to one of scroll down and scroll right.

For example, the first rotation input along the direction 1812 may correspond to the second rotation input along the direction 1802. A function of the external electronic device 300 performed based on the first rotation input along the direction 1812 may correspond to a function of the external electronic device 300 performed based on the second rotation input along the direction 1802. The function of the external electronic device 300 performed based on the first rotation input along the direction 1812 and/or the second rotation input along the direction 1802 may be set to one of scroll up and scroll left.

According to an embodiment of the disclosure, while a screen 1861 is displayed through the display 330 of the external electronic device 300, a screen may be changed based on the first rotation input and/or the second rotation input. For example, when the screen is changed based on the first rotation input and/or the second rotation input, a visual effect representing that the screen is changed along a horizontal direction may be displayed together.

Based on the first rotation input along the direction 1811 and/or the second rotation input along the direction 1801, a screen displayed through the display 330 of the external electronic device 300 may be changed along a direction 1821. For example, based on the first rotation input along the direction 1811 and/or the second rotation input along the direction 1801, the screen displayed through the display 330 of the external electronic device 300 may be changed in an order of the screen 1861, a screen 1862, a screen 1863, and a screen 1864 along the direction 1821. After the screen 1864 is displayed, the screen 1861 may be displayed again based on the first rotation input along the direction 1811 and/or the second rotation input along the direction 1801.

Based on the first rotation input along the direction 1812 and/or the second rotation input along the direction 1802, a screen displayed through the display 330 of the external electronic device 300 may be changed along a direction 1822. For example, based on the first rotation input along the direction 1812 and/or the second rotation input along the direction 1802, the screen displayed through the display 330 of the external electronic device 300 may be changed in an order of the screen 1861, the screen 1864, the screen 1863, and the screen 1862 along the direction 1822. After the screen 1862 is displayed, the screen 1861 may be displayed based on the first rotation input along the direction 1812 and/or the second rotation input along the direction 1802.

According to an embodiment of the disclosure, while a screen 1871 is displayed through the display 330 of the external electronic device 300, a screen may be changed based on the first rotation input and/or the second rotation input. For example, when the screen is changed based on the first rotation input and/or the second rotation input, a visual effect representing that the screen is changed along a vertical direction may be displayed together.

Based on the first rotation input along the direction 1811 and/or the second rotation input along the direction 1801, a screen displayed through the display 330 of the external electronic device 300 may be changed along the direction 1831. For example, based on the first rotation input along the direction 1811 and/or the second rotation input along the direction 1801, the screen displayed through the display 330 of the external electronic device 300 may be changed in an order of the screen 1871, a screen 1872, a screen 1873, a screen 1874, a screen 1875, a screen 1876, and a screen 1877 along a direction 1831. After the screen 1877 is displayed, the screen 1871 may be displayed again based on the first rotation input along the direction 1811 and/or the second rotation input along the direction 1801.

Based on the first rotation input along the direction 1812 and/or the second rotation input along the direction 1802, a screen displayed through the display 330 of the external electronic device 300 may be changed along the direction 1832. For example, based on the first rotation input along the direction 1812 and/or the second rotation input along the direction 1802, the screen displayed through the display 330 of the external electronic device 300 may be changed in an order of the screen 1871, the screen 1877, the screen 1876, the screen 1875, the screen 1874, the screen 1873, and the screen 1872 along the direction 1832. After the screen 1872 is displayed, the screen 1871 may be displayed again based on the first rotation input along the direction 1812 and/or the second rotation input along the direction 1802.

Although not illustrated, the smart ring device 200 may perform an operation similar to the above-described operation even in a state of not being worn by a user. For example, even in a state in which the smart ring device 200 is placed on a floor or is supported by an external object, a function of the external electronic device 300 corresponding to the rotation input identified in the smart ring device 200 may be performed. According to an embodiment of the disclosure, a processor 210 may identify a direction of the rotation input based on a wearing direction (or orientation) of the smart ring device 200.

Although not illustrated, the screen displayed through the display 330 of the external electronic device 300 may further include a visual object representing a connection with the smart ring device 200 and that an operation of the external electronic device 300 is controlled by the smart ring device 200.

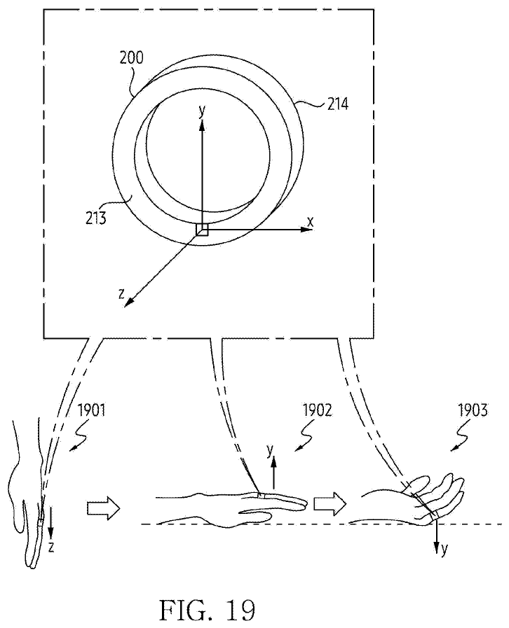

FIG. 19 illustrates an operation for identifying a wearing direction of a smart ring device according to an embodiment of the disclosure.

Referring to FIG. 19, as a wearing direction of a smart ring device 200 is not fixed, even when a user performs the same operation according to the wearing direction, the smart ring device 200 may determine as a different rotation input. For example, in a case that the smart ring device 200 is worn on the user's finger, a rotation input may be changed according to whether a hand wearing the smart ring device 200 is a left hand or a right hand. For example, the rotation input may be changed according to the wearing direction of the smart ring device 200.

According to an embodiment of the disclosure, a processor 210 of the smart ring device 200 may identify the wearing direction of the smart ring device 200 by using an acceleration sensor 231 and/or a gyro sensor 232. For example, the processor 210 may identify the hand wearing the smart ring device 200 and/or the wearing direction of the smart ring device 200 by using the acceleration sensor 231 and/or the gyro sensor 232. The processor 210 may identify the wearing direction of the smart ring device 200 based on identifying a gravity direction using the acceleration sensor 231 and/or the gyro sensor 232. The processor 210 may set three axes (e.g., an x-axis, a y-axis, and a z-axis) based on the smart ring device 200. The processor 210 may set a direction in which a first side surface 213 faces as the z-axis. The processor 210 may set a direction in which a second side surface 214 opposite to the first side surface 213 faces as a −z axis.

According to an embodiment of the disclosure, the processor 210 may request to sequentially take a posture 1901, a posture 1902, and a posture 1903.

The processor 210 may request the user to take the posture 1901. For example, the processor 210 may request the user to take an attention posture together with the hand wearing the smart ring device 200. In a case that the smart ring device 200 is worn in a first direction as illustrated in FIG. 5A, in the posture 1901, a z-axis direction, which is the direction in which the first side surface 213 of the smart ring device 200 faces, may correspond to the gravity direction. The processor 210 may identify the wearing direction of the smart ring device 200 based on identifying that the z-axis direction, which is the direction in which the first side surface 213 faces, corresponds to the gravity direction.

After identifying the wearing direction of the smart ring device 200, the processor 210 may request the user to take the posture 1902. For example, the processor 210 may request the user to place the hand wearing the smart ring device 200 down toward a desk. In the posture 1902, a −y-axis direction identified by the smart ring device 200 may correspond to the gravity direction. Based on the processor 210 identifying that the −y-axis direction corresponds to the gravity direction, the processor 210 may identify an angle at which the y-axis is rotated based on the gravity direction. The processor 210 may identify a wearing state of the smart ring device 200 based on the identified angle.

After the processor 210 identifies the wearing state of the smart ring device 200, the processor 210 may request the user to take the posture 1903. For example, the processor 210 may request a palm to be turned upward. In the posture 1903, a y-axis direction identified by the smart ring device 200 may correspond to the gravity direction. The processor 210 may identify a direction in which the z-axis is rotated (e.g., clockwise or counterclockwise) while the user's posture changes from the posture 1902 to the posture 1903. The processor 210 may identify a yaw value based on the direction in which the z-axis is rotated. Based on the yaw value, the processor 210 may identify the hand on which the smart ring device 200 is worn as one of the left hand and the right hand. As an example, while the user's posture is changed from the posture 1902 to the posture 1903, the processor 210 may identify the hand on which the smart ring device 200 is worn as the left hand, based on identifying that the z-axis rotates counterclockwise. As an example, while the user's posture is changed from the posture 1902 to the posture 1903, the processor 210 may identify the hand on which the smart ring device 200 is worn as the right hand based on identifying that the z-axis rotates clockwise.

Based on the above-described operations, the processor 210 may identify the hand wearing the smart ring device 200 and/or the wearing direction of the smart ring device 200. The processor 210 may identify a direction of the rotation input based on the hand wearing the smart ring device 200 and/or the wearing direction of the smart ring device 200.

Although not illustrated, in a case that the smart ring device 200 is placed on the ground, the processor 210 may identify whether a direction of the z-axis corresponds to the gravity direction, by using the acceleration sensor 231 and/or the gyro sensor 232. The processor 210 may identify that the first side surface 213 faces the ground based on identifying that the direction of the z-axis corresponds to the gravity direction. The processor 210 may identify whether the direction of the z-axis is opposite to the gravity direction, by using the acceleration sensor 231 and/or the gyro sensor 232. The processor 210 may identify that the second side surface 214 faces the ground based on identifying that the direction of the z-axis is opposite to the gravity direction.

For example, the processor 210 may identify (or estimate) the direction of the rotation input based on a phase difference between a structure 215 and a housing 201, a swipe input to a ring, information on the z-axis rotation (e.g., the yaw value), or information on a phase difference of a signal pattern identified by a PPG sensor 233.

According to the above-described embodiment of the disclosure, the processor 210 may identify the direction of the rotation input and perform a function mapped to the identified direction of the rotation input. According to an embodiment of the disclosure, the processor 210 may transmit raw data to an external electronic device 300. Based on the raw data, the external electronic device 300 may control a screen displayed on a display 330. According to an embodiment of the disclosure, the processor 210 may transmit, to the external electronic device 300, information on the rotation input (e.g., a rotation direction or rotation speed) identified based on the raw data. The external electronic device 300 may control the screen displayed on the display 330 based on the information on the rotation input.

According to an embodiment of the disclosure, the processor 210 may request the user to perform the rotation input in a specified direction. The processor 210 may store the direction of the rotation input in the memory 240 based on the rotation input received from the user.

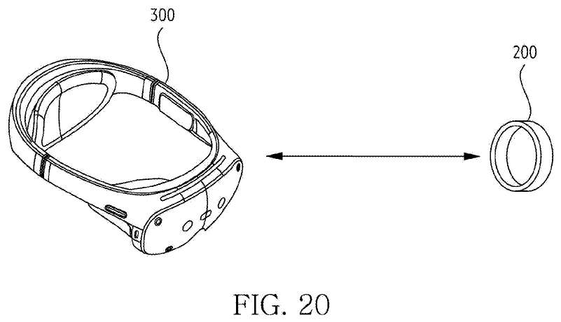

FIG. 20 illustrates an example in which a smart ring device is connected to an external electronic device according to an embodiment of the disclosure.

Referring to FIG. 20, an external electronic device 300 may provide an AR service and/or a VR service. For example, the external electronic device 300 may be referred to as a head mounted display (HMD) device. For example, a rotation input of a smart ring device 200 may be used for an input of the external electronic device 300.

According to an embodiment of the disclosure, the external electronic device 300 may include an input device in a wheel-type input device or another type of input device for receiving a rotation input type of a user. For example, the external electronic device 300 may include a physical button, a touch input device, or a pressure input device. Although the physical button, the touch input device, or the pressure input device may not directly provide a rotational-type input, the external electronic device 300 may convert an input identified by the physical button, the touch input device, or the pressure input device, by software processing, into a rotation input.

As an example, the external electronic device 300 may identify the number of times that a press input of the physical button is identified as an input according to rotation of a wheel. As an example, the external electronic device 300 may convert a slide input identified in a touch input region into the rotation of the wheel for the rotation input and a rotation speed value. As an example, the external electronic device 300 may convert an area, pressure intensity, and holding time of a pressure input identified by the pressure input device into a rotation amount and a rotation speed value of the wheel.

According to an embodiment of the disclosure, the external electronic device 300 may include at least one of a dial, a jog shuttle, and a rotation input device. The external electronic device 300 may identify a rotation amount and/or rotation speed by using at least one of the dial, the jog shuttle, and the rotation input device. The external electronic device may convert the rotation input into an input of another input device based on the rotation amount and/or the rotation speed.

According to an embodiment of the disclosure, the external electronic device 300 may include various input units for receiving a rotation input. For example, the external electronic device 300 may include a wheel input device for controlling a volume. For example, the external electronic device 300 may include a wheel input device for adjusting a pupil distance. For example, the external electronic device 300 may include a wheel input device for adjusting elasticity of a band that controls the external electronic device 300 to fit closely to the user's head.

For example, the external electronic device 300 may include a wheel input device for adjusting an immersion level of a virtual environment. As an example, the external electronic device 300 may change a degree of expression of an image displayed on a screen based on an amount of rotation input. The external electronic device 300 may change a ratio between an input image identified through a camera and an image for the virtual environment displayed on the screen based on rotation of the wheel input device. As an example, the external electronic device 300 may change transparency of contents in a region excluding a content in a region at which the user gazes, based on the wheel input device. The external electronic device 300 may increase a sense of immersion of the user by changing the transparency of the contents in the region excluding the content in the region at which the user gazes.

At least one of rotation inputs through various wheel input devices included in the external electronic device 300 described above may be provided through the rotation input of the smart ring device 200. For example, at least a part of the rotation inputs through various wheel input devices included in the external electronic device 300 may be performed based on the rotation input of the smart ring device 200. The user may control the external electronic device 300 based on the rotation input of the smart ring device 200 without moving a hand to the external electronic device 300.

According to an embodiment of the disclosure, a function according to the rotation input of the smart ring device 200 may be performed in association with at least one of the user's gaze, the user's voice command, and/or the user's gesture identified in the external electronic device 300.

For example, the external electronic device 300 may identify the rotation input of the smart ring device 200 while the user looks at a volume adjustment icon. The external electronic device 300 may change a size of the volume based on the rotation input identified while the user looks at the volume adjustment icon.

For example, the external electronic device 300 may identify the rotation input of the smart ring device 200 while the user gazes at a photograph displayed on the screen. The external electronic device 300 may perform one of enlargement and/or reduction of the photograph based on the rotation input identified while the user gazes at the photograph displayed on the screen.

For example, the external electronic device 300 may identify the rotation input of the smart ring device 200 together with a voice command, such as “immersion adjustment,” from the user. The external electronic device 300 may adjust various factors for adjusting a sense of immersion based on the voice command and the rotation input of the smart ring device 200.

In the above-described embodiment of the disclosure, an example in which a function corresponding to the input of the physical button of the external electronic device 300 is provided through the rotation input of the smart ring device 200 has been described, but it is not limited thereto. For example, a function provided in the screen provided by the external electronic device 300 may be performed based on the rotation input of the smart ring device 200.

According to an embodiment of the disclosure, based on the rotation input of the smart ring device 200, a function corresponding to an input of various buttons of the external electronic device 300 may be performed. As described above, the rotation input of the smart ring device 200 may be converted into another type of input. As an example, in a case that the rotation input is converted into the pressure input, a rotation amount and rotation speed related to the rotation input may be converted into pressure intensity (or a pressure amount) and input speed of a button, respectively. As an example, in a case that the rotation input is converted into the touch input (or a swipe input), the rotation amount and the rotation speed related to the rotation input may be converted into a movement region and movement speed of a touch, respectively.

As described above, a specified function of the external electronic device 300 directly or indirectly connected to the smart ring device 200 may be performed based on the rotation input of the smart ring device 200.

According to an embodiment of the disclosure, the touch input device may be disposed on a part of a housing of the external electronic device 300 exposed to the outside. At least a part of functions assigned to the touch input device may be performed based on the rotation input of the smart ring device 200. For example, a scroll operation, an image enlargement operation, and an image reduction operation through the touch input may be performed based on the rotation input of the smart ring device 200.

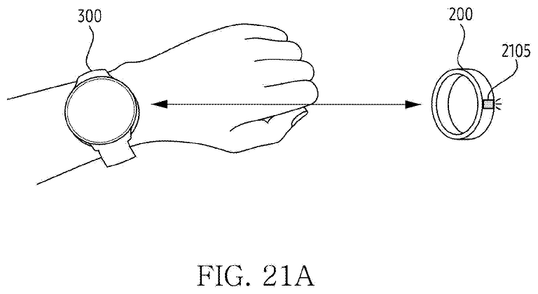

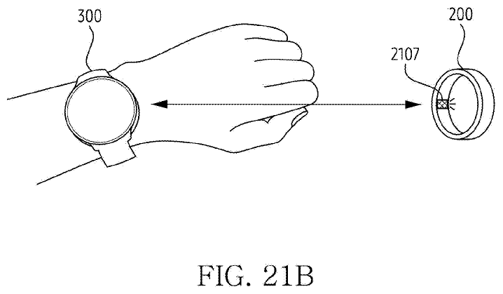

FIG. 21A illustrates a connection between a smart ring device and an external electronic device according to an embodiment of the disclosure.

FIG. 21B illustrates a connection between a smart ring device and an external electronic device according to an embodiment of the disclosure.

Referring to FIGS. 21A and 21B, a processor 210 of a smart ring device 200 may establish a connection with an external electronic device 300. The processor 210 of the smart ring device 200 may provide a user with a notification representing the connection with the external electronic device 300. For example, the smart ring device 200 may include at least one of a sensor (e.g., a PPG sensor 233 or an LED) including a light emitter, a speaker, or a vibration actuator. The processor 210 may provide the notification representing the connection with the external electronic device 300 by using at least one of the sensor (e.g., the PPG sensor 233 or the LED) including the light emitter, the speaker, or the vibration actuator. According to an embodiment of the disclosure, the processor 210 may provide a notification based on a connection with two or more external devices including the external electronic device 300.

Referring to FIG. 21A, the smart ring device 200 may include a sensor 2105 disposed in an external housing portion 204 (or a second surface 212) and including a light emitter. The processor 210 may emit light of a specified color through the light emitter in response to establishing the connection with the external electronic device 300.

Referring to FIG. 21B, the smart ring device 200 may include a sensor 2107 disposed in an inner housing portion 203 (or a first surface 211) and including a light emitter. The processor 210 may emit light of a specified color through the light emitter in response to establishing the connection with the external electronic device 300. According to an embodiment of the disclosure, in a case that the smart ring device 200 including the sensor disposed in the inner housing portion 203 is worn by the user, light emitted from the sensor may not be recognized by the user. Therefore, in a case of being worn by the user, the smart ring device 200 may not emit light using the sensor 2107. When the smart ring device 200 is in a state of not being worn or operates by being coupled (or attached) to another device, the processor 210 may emit the light of the specified color by using the sensor 2107 including the light emitter disposed in the inner housing portion 203.

FIGS. 21A and 21B illustrate an example in which the notification is outputted from the smart ring device 200 in a case that the connection with the external electronic device 300 is established, but are not limited thereto. The smart ring device 200 may output a notification representing that the external electronic device 300 is being connected. For example, a color (e.g., red) of light emitted according to the notification representing that the external electronic device 300 is being connected may be distinguished from a color (e.g., green) of light emitted according to the notification representing that the connection with the external electronic device 300 has been established.

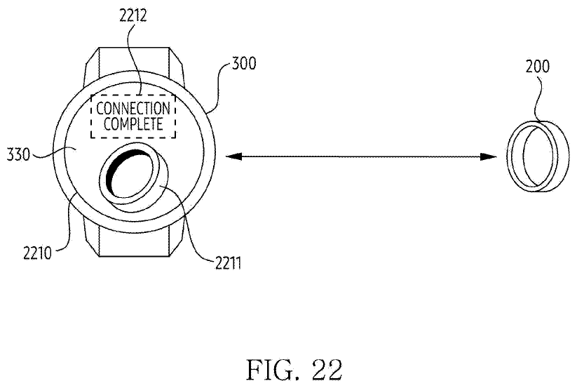

FIG. 22 illustrates a connection between a smart ring device and an external electronic device according to an embodiment of the disclosure.

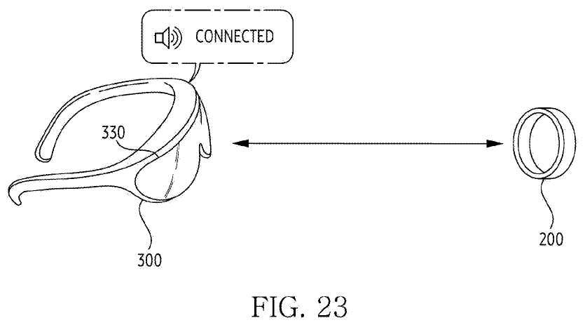

FIG. 23 illustrates a connection between a smart ring device and an external electronic device according to an embodiment of the disclosure.

Referring to FIGS. 22 and 23, a processor 210 of a smart ring device 200 may establish a connection with an external electronic device 300. The external electronic device 300 may provide a user with a notification representing the connection with the smart ring device 200.

Referring to FIG. 22, the external electronic device 300 may display, through a display 330 of the external electronic device 300, a screen 2210 representing that the connection with the smart ring device 200 has been established. The screen 2210 may include a visual object 2211 corresponding to the smart ring device 200 and text 2212 representing that the connection with the smart ring device 200 has been established. As an example, the visual object 2211 may be displayed as a rotating animation.

Referring to FIG. 23, the external electronic device 300 may output the notification representing that the connection with the smart ring device 200 has been established through a speaker (not illustrated) of the external electronic device 300. The external electronic device 300 may output a voice signal representing that the connection with the smart ring device 200 has been established. Although not illustrated, the external electronic device 300 may provide the notification representing that the connection with the smart ring device 200 has been established by using a virtual screen including the smart ring device 200.

FIGS. 22 and 23 illustrate a notification is outputted from the external electronic device 300 in a case that the connection with the smart ring device 200 is established, but are not limited thereto. The external electronic device 300 may also output a notification representing that the smart ring device 200 is being connected. According to an embodiment of the disclosure, the external electronic device 300 may include at least one of a sensor (e.g., a PPG sensor or an LED) including a light emitter, a speaker, and a vibration actuator. The external electronic device 300 may provide the notification representing that the connection with the smart ring device 200 has been established by using at least one of the sensor (e.g., the PPG sensor or the LED) including the light emitter, the speaker, or the vibration actuator.

In FIGS. 22 and 23, an example in which the external electronic device 300 provides the notification representing that the connection with the smart ring device 200 has been established has been described, but it is not limited thereto. While the notification representing that the connection with the smart ring device 200 has been established is provided by the external electronic device 300, the smart ring device 200 may provide the notification representing the connection with the external electronic device 300 as illustrated in FIGS. 21A and 21B.

Although not illustrated, according to an embodiment of the disclosure, based on the connection between the external electronic device 300 and the smart ring device 200 being established, a notification representing that the connection between the external electronic device 300 and the smart ring device 200 has been established may be provided by another external electronic device. For example, in a case that it is difficult for the external electronic device 300 and the smart ring device 200 to provide the notification, the notification may be provided through a nearby connectable device or a device (e.g., the another external electronic device) connected to the external electronic device 300 and the smart ring device 200.

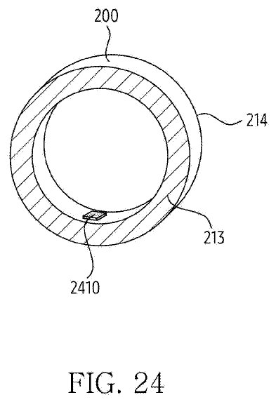

FIG. 24 illustrates a perspective view of a smart ring device according to an embodiment of the disclosure.

Referring to FIG. 24, a smart ring device 200 may include a first light emitter 2410 for identifying information (e.g., health information) on a user. The first light emitter 2410 may be an example of one or more light emitting circuits 233-1 of a PPG sensor 233 of the smart ring device 200.

For example, the smart ring device 200 may include a second light emitter (not illustrated) for representing a connection with an external electronic device. Light emitted from the second light emitter (not illustrated) for representing the connection with the external electronic device may be emitted from a first side surface 213 and a second side surface 214 through a waveguide structure. A processor 210 may emit light from the first side surface 213 and the second side surface 214 by using the second light emitter (not illustrated) so that the user of the smart ring device 200 may identify that the connection with the external electronic device 300 has been established even in a state of wearing the smart ring device 200.

According to an embodiment of the disclosure, the processor 210 may control the first light emitter 2410 and the second light emitter (not illustrated) according to an operation mode of the smart ring device 200. For example, the processor 210 may deactivate the second light emitter (not illustrated) while identifying the information (e.g., the health information) on the user. The processor 210 may deactivate the second light emitter (not illustrated) to prevent interference by light emitted through the second light emitter (not illustrated).

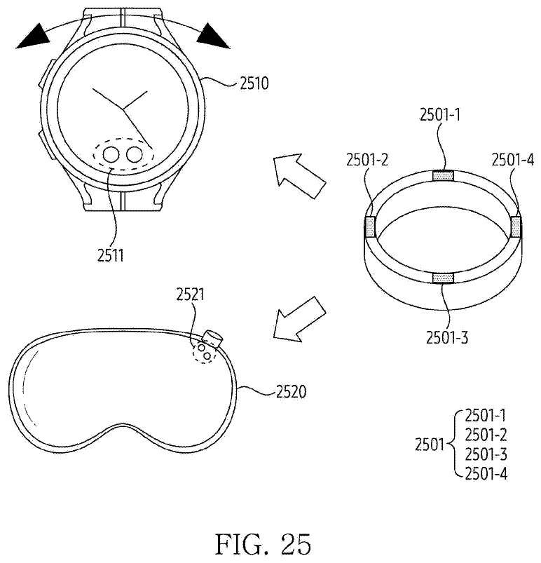

FIG. 25 illustrates a smart ring device capable of being coupled with an external electronic device according to an embodiment of the disclosure.

Referring to FIG. 25, a smart ring device 200 may include a plurality of magnetic materials 2501. For example, the smart ring device 200 may include four magnetic materials. The smart ring device 200 may include a magnetic material 2501-1, a magnetic material 2501-2, a magnetic material 2501-3, and a magnetic material 2501-4.

A watch-shaped external electronic device 2510 may include a Hall IC 2511. An external electronic device 2510 may identify that a magnetic material is in contact with a surface on which the Hall IC 2511 is disposed, based on a signal identified by the Hall IC 2511. The external electronic device 2510 may identify that the smart ring device 200 is in contact with the surface on which the Hall IC 2511 is disposed, based on identifying that the magnetic material is in contact with the surface on which the Hall IC 2511 is disposed. According to an embodiment of the disclosure, the external electronic device 2510 may establish a connection (e.g., NFC communication connection or Bluetooth communication connection) with the smart ring device 200 to identify whether the contacted magnetic material is a magnetic material included in the smart ring device 200.

An external electronic device 2520 for providing an AR service and/or a VR service may include a Hall IC 2521. The external electronic device 2520 may identify that a magnetic material is in contact with a surface on which the Hall IC 2521 is disposed, based on a signal identified by the Hall IC 2521. The external electronic device 2520 may identify that the smart ring device 200 is in contact with the surface on which the Hall IC 2521 is disposed, based on identifying that the magnetic material is in contact with the surface on which the Hall IC 2521 is disposed. According to an embodiment of the disclosure, the external electronic device 2520 may establish a connection (e.g., NFC communication connection or Bluetooth communication connection) with the smart ring device 200 to identify whether the contacted magnetic material is a magnetic material included in the smart ring device 200.

According to an embodiment of the disclosure, the smart ring device 200 may provide a rotation input in a state of being in contact with (or attached to) a part of an external electronic device (e.g., the external electronic device 2510 or the external electronic device 2520). For example, in a state in which the smart ring device 200 is in contact with (or attached to) the part of the external electronic device (e.g., the external electronic device 2510 or the external electronic device 2520), a structure 215 of the smart ring device 200 may be rotated. The external electronic device (e.g., the external electronic device 2510 or the external electronic device 2520) may identify the rotation input based on rotation of the structure 215.

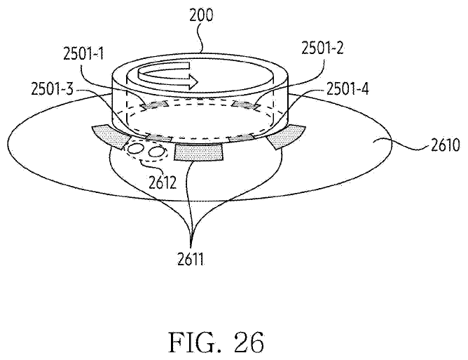

FIG. 26 illustrates a smart ring device capable of being coupled with an external electronic device according to an embodiment of the disclosure.

Referring to FIG. 26, a smart ring device 200 may operate in a state of being in contact with an external electronic device 2610. The external electronic device 2610 may include a Hall IC 2612. The external electronic device 2610 may identify that the smart ring device 200 approaches the external electronic device 2610 by using the Hall IC 2612. The external electronic device 2610 may correspond to the external electronic device 2510 or the external electronic device 2520 of FIG. 25. For example, the Hall IC 2612 may be configured with two or more Hall ICs. The external electronic device 2610 may identify a direction of a rotation input through the smart ring device 200 based on an amount of change in signals obtained from the two or more Hall ICs.

According to an embodiment of the disclosure, in a case that the external electronic device 2610 is configured in a watch shape, in the external electronic device 2610, the Hall IC 2612 may be disposed on a surface corresponding to a display, such as the external electronic device 2510 of FIG. 25. The external electronic device 2610 may identify that the smart ring device 200 approaches (or contacts) by using the Hall IC 2612. The external electronic device 2610 may display, through the display, a screen for guiding an attachment (or a contact) through a shape of the smart ring device.

According to an embodiment of the disclosure, the external electronic device 2610 may include a coupling structure 2611 for guiding fastening of the smart ring device 200. The coupling structure 2611 may include one or more coupling portions. According to an embodiment of the disclosure, in the external electronic device 2610, a magnetic material may be disposed at a position where the smart ring device 200 is fastened (or a position where the coupling structure 2611 is disposed). Based on the magnetic material of the external electronic device 2610 and a magnetic material of the smart ring device 200, the smart ring device 200 may be fastened to the external electronic device 2610.

According to an embodiment of the disclosure, in a case that the external electronic device 2610 is a wearable device for providing an AR service and/or a VR service, the external electronic device 2610 may include a protruding interface in which the smart ring device 200 disposed at an upper end or a side surface of the external electronic device 2610 may be mounted. The protruding interface may be configured to be inserted into a hole 270 of the smart ring device 200. The external electronic device 2610 may identify a rotation input (or a rotation direction of the rotation input) of the smart ring device 200 by using the Hall IC 2612.

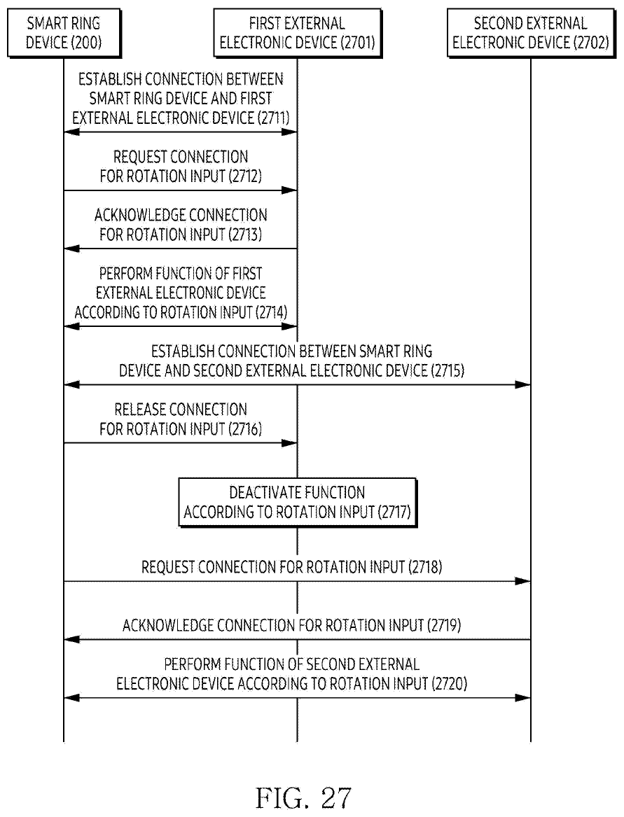

FIG. 27 illustrates an operation of a smart ring device, a first external electronic device, and a second external electronic device according to an embodiment of the disclosure.

Referring to FIG. 27, in operation 2711, a smart ring device 200 may establish a connection with a first external electronic device 2701. The first external electronic device 2701 may establish the connection with the smart ring device 200.

In operation 2712, the smart ring device 200 may request, from the first external electronic device 2701, a connection for a rotation input. The smart ring device 200 may transmit a message for requesting the connection for the rotation input to the first external electronic device 2701. The smart ring device 200 may request the first external electronic device 2701 to set an interface for the rotation input based on the message.

In operation 2713, the first external electronic device 2701 may transmit, to the smart ring device 200, a message to acknowledge the connection for the rotation input. The smart ring device 200 may receive, from the first external electronic device 2701, the message to acknowledge the connection for the rotation input.

For example, the first external electronic device 2701 may identify whether a processing unit for processing the rotation input exists. The first external electronic device 2701 may transmit, to the smart ring device 200, the message to acknowledge the connection for the rotation input based on identifying that the processing unit for processing the rotation input exists.

In operation 2714, the first external electronic device 2701 may perform a function of the first external electronic device 2701 according to the rotation input of the smart ring device 200. For example, the smart ring device 200 may identify the rotation input. The smart ring device 200 may transmit, to the first external electronic device 2701, information on the rotation input. The first external electronic device 2701 may perform a function mapped to the rotation input based on the information on the rotation input.

According to an embodiment of the disclosure, in a case of establishing the connection with the smart ring device 200, the first external electronic device 2701 may perform a function performed according to the rotation input identified by the first external electronic device 2701 based on the rotation input of the smart ring device 200.

According to an embodiment of the disclosure, in a case of establishing the connection with the first external electronic device 2701, the smart ring device 200 may not perform a function performed according to the rotation input identified by the smart ring device 200. The smart ring device 200 may transmit the information on the rotation input to the first external electronic device 2701.

According to an embodiment of the disclosure, the smart ring device 200 and the first external electronic device 2701 may exchange information using Bluetooth communication. For example, the smart ring device 200 and the first external electronic device 2701 may maintain the connection based on the Bluetooth communication or Bluetooth low energy (BLE) communication. Based on the connection, the smart ring device 200 may transmit the information on the rotation input to the first external electronic device 2701, and the first external electronic device 2701 may perform the function according to the rotation input.

According to an embodiment of the disclosure, the smart ring device 200 and the first external electronic device 2701 may transmit and receive information based on broadcasting without a direct connection. In a case that the broadcasting method is used, the first external electronic device 2701 may standby in a listening mode. Based on the first external electronic device 2701 standing by in the listening mode, power consumption for receiving the information on the rotation input transmitted from the smart ring device 200 may be reduced in the first external electronic device 2701.

According to an embodiment of the disclosure, the smart ring device 200 may be configured to transmit and receive information with the first external electronic device 2701 only at a specified timing (or a specified period). The first external electronic device 2701 may continuously determine whether the smart ring device 200 exists and receive various information from the smart ring device 200. According to an embodiment of the disclosure, the specified timing (or the specified period) at which the smart ring device 200 transmits and receives information with the first external electronic device 2701 may be dynamically changed.

In operation 2715, the smart ring device 200 may establish a connection with a second external electronic device 2702. The second external electronic device 2702 may establish the connection with the smart ring device 200.

In operation 2716, the smart ring device 200 may request a disconnection for a rotation input from the first external electronic device 2701. For example, the smart ring device 200 may transmit, to the first external electronic device 2701, a message for requesting the disconnection for the rotation input. The first external electronic device 2701 may receive, from the smart ring device 200, the message for requesting the disconnection for the rotation input.

In operation 2717, the first external electronic device 2701 may deactivate the function according to the rotation input. For example, in a case that the first external electronic device 2701 does not include a device for the rotation input, the processing unit for processing the rotation input included in the first external electronic device 2701 may be deactivated. For example, in a case that the first external electronic device 2701 includes the device for the rotation input, at least one component (e.g., a display) for performing the function with respect to the rotation input identified by the first external electronic device 2701 may be activated.

In operation 2718, the smart ring device 200 may request, from the second external electronic device 2702, a connection for a rotation input. The operation 2718 may correspond to the operation 2712.

In operation 2719, the second external electronic device 2702 may transmit, to the smart ring device 200, a message to acknowledge the connection for the rotation input. The operation 2719 may correspond to the operation 2713.

In operation 2720, the second external electronic device 2702 may perform a function of the second external electronic device 2702 according to the rotation input of the smart ring device 200. The operation 2720 may correspond to the operation 2714.

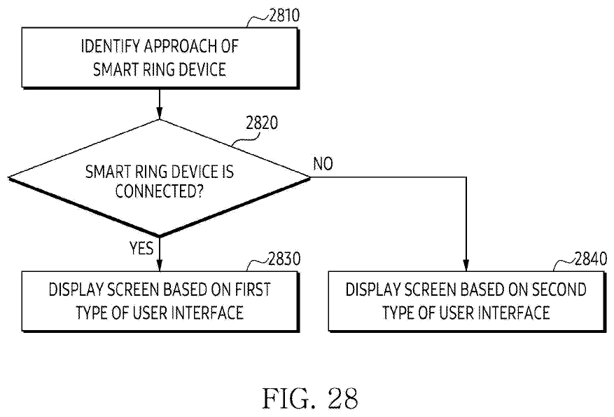

FIG. 28 illustrates a flowchart related to an operation of an external electronic device according to an embodiment of the disclosure.

In the following embodiment of the disclosure, each of operations may be sequentially performed, but is not necessarily performed sequentially. For example, an order of each of the operations may be changed, and at least two operations may be performed in parallel. Operations described below may be performed in an external electronic device 300.

Referring to FIG. 28, in operation 2810, the external electronic device 300 (or a processor 310 of the external electronic device 300) may identify approach of a smart ring device 200. For example, the external electronic device 300 may identify the approach of the smart ring device 200 by using a Hall IC. The external electronic device 300 may identify the approach of the smart ring device 200 based on a signal identified through the Hall IC.

In operation 2820, the external electronic device 300 may identify whether the smart ring device 200 is connected. The external electronic device 300 may identify whether a surface of the smart ring device 200 is in contact with the external electronic device 300, by using the Hall IC. The external electronic device 300 may identify whether the connection with the smart ring device 200 positioned within a specified distance has been established.

In operation 2830, in a case that the smart ring device 200 is connected, the external electronic device 300 may display a screen based on a first type of user interface. For example, the first type of user interface may include a user interface controllable according to a rotation input.

Although not illustrated, the external electronic device 300 may identify that the connection with the smart ring device 200 is released. Based on identifying that the connection with the smart ring device 200 is released, the external electronic device 300 may change a screen displayed based on the first type of user interface to a screen displayed based on a second type of user interface.

In operation 2840, in a case that the smart ring device 200 is not connected, the external electronic device 300 may display the screen based on the second type of user interface. For example, the second type of user interface may include a user interface controllable according to an input (e.g., a swipe input, a button input, or a pressure input) distinct from the rotation input.

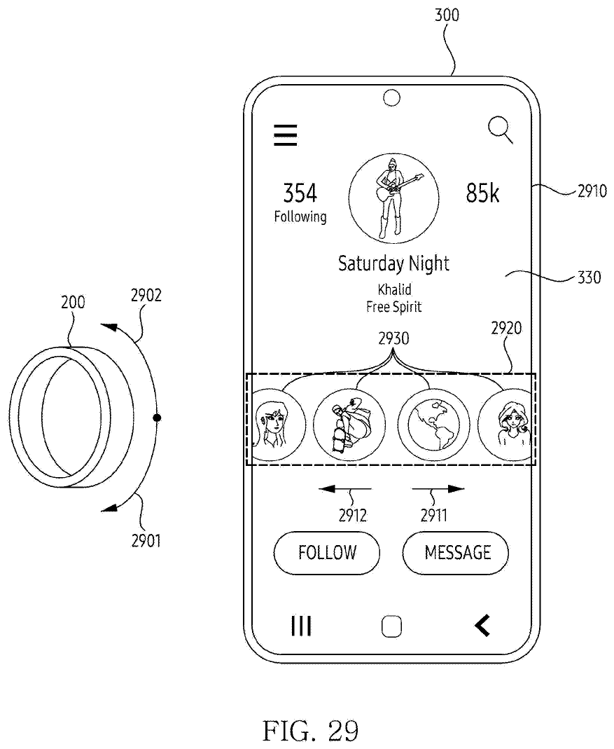

FIG. 29 illustrates an operation of a smart ring device and an external electronic device according to an embodiment of the disclosure.

Referring to FIG. 29, a smart ring device 200 may be communicatively connected to an external electronic device 300. In a case that the external electronic device 300 and the smart ring device 200 are communicatively connected, a series of operations (e.g., the operation 2714 or the operation 2720 of FIG. 27) performing a part of a function of the external electronic device 300 may be performed based on a rotation input of the smart ring device 200. Based on execution of an application, the external electronic device 300 may identify whether the executed application supports the rotation input.

For example, a specified application executed in the external electronic device 300 may support a function with respect to the rotation input. Based on execution of the specified application, the external electronic device 300 may set a function of the specified application to be performed through the rotation input.

For example, the specified application may be a music playback application. The external electronic device 300 may display, through a display 330, a screen 2910 including a user interface related to the specified application. The screen 2910 may include a region 2920 for displaying a music list 2930 to be played. In the region 2920, an indication of the music list 2930 may be changed based on the rotation input of the smart ring device 200. As an example, based on a rotation input along a direction 2901 identified by the smart ring device 200, the indication of the music list 2930 in the region 2920 may be moved along a direction 2911. As an example, based on a rotation input along a direction 2902 identified by the smart ring device 200, the indication of the music list 2930 in the region 2920 may be moved along a direction 2912.

According to an embodiment of the disclosure, the external electronic device 300 may represent that an indication of content (i.e., the music list 2930) displayed in the region 2920 may be changed by the rotation input of the smart ring device 200. As an example, the external electronic device 300 may change a color of the region 2920 and/or visual objects (e.g., icons for representing the music list 2930) included in the region 2920.

According to an embodiment of the disclosure, based on the termination of the specified application, the external electronic device 300 may not receive information on the rotation input from the smart ring device 200.

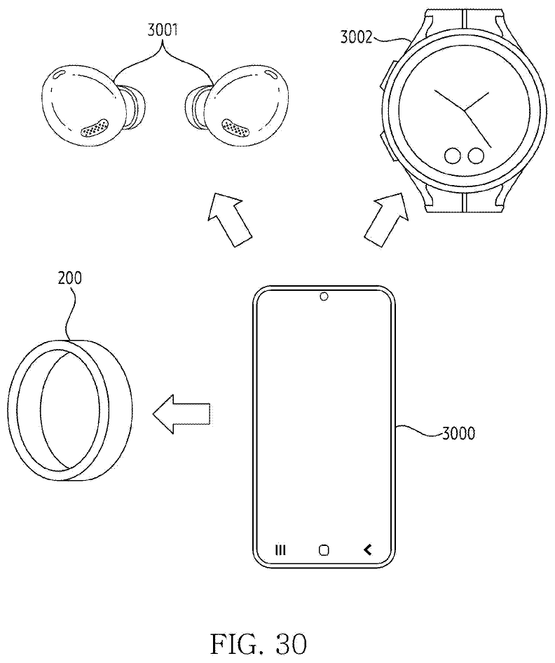

FIG. 30 illustrates an operation of a smart ring device and external electronic devices according to an embodiment of the disclosure.

Referring to FIG. 30, a smart ring device 200 may establish a connection with a electronic device 3000. The smart ring device 200 may not be directly connected to an external electronic device 3001 and an external electronic device 3002.

The smart ring device 200 may be connected to the external electronic device 3001 and the external electronic device 3002 through the electronic device 3000. The electronic device 3000 may support a connection between the smart ring device 200 and one or more external electronic devices (e.g., the external electronic device 3001 and the external electronic device 3002).

The electronic device 3000 may receive information on a rotation input from the smart ring device 200. The electronic device 3000 may display a screen for determining an external electronic device (e.g., the external electronic device 3001 or the external electronic device 3002) to transmit the information on the rotation input received from the smart ring device 200. The electronic device 3000 may receive, from a user, an input for determining the external electronic device to transmit the information on the rotation input received from the smart ring device 200. The electronic device 3000 may transmit the information on the rotation input received from the smart ring device 200 to the external electronic device (e.g., the external electronic device 3001 or the external electronic device 3002) determined based on the received input.

According to an embodiment of the disclosure, one of the external electronic device 3001 and the external electronic device 3002 may be tagged with the smart ring device 200. For example, in a case that the smart ring device 200 is tagged with the external electronic device 3001, the smart ring device 200 may transmit information on the external electronic device 3001 to the electronic device 3000. The electronic device 3000 may transmit the information on the rotation input to the external electronic device 3001 based on the information on the external electronic device 3001.

After the smart ring device 200 is tagged with the external electronic device 3001, the smart ring device 200 may be tagged with the external electronic device 3002. The smart ring device 200 may change a target device with respect to the information on the rotation input. The smart ring device 200 may change the target device with respect to the information on the rotation input from the external electronic device 3001 to the external electronic device 3002. The smart ring device 200 may transmit, to the electronic device 3000, information representing that the target device for the information on the rotation input has been changed from the external electronic device 3001 to the external electronic device 3002. Based on the information received from the smart ring device 200, the electronic device 3000 may transmit the information on the rotation input to the external electronic device 3002.

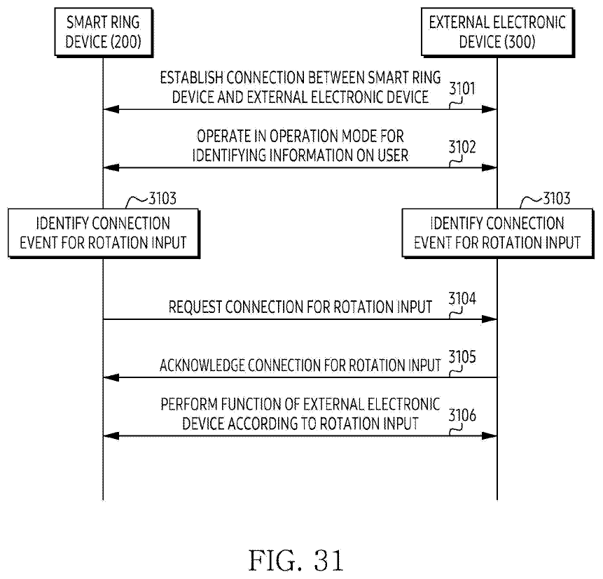

FIG. 31 illustrates an operation of a smart ring device and external electronic devices according to an embodiment of the disclosure.

Referring to FIG. 31, in operation 3101, a smart ring device 200 may establish a connection with an external electronic device 300. For example, the operation 3101 may correspond to the operation 2711 of FIG. 27.

In operation 3102, the smart ring device 200 and the external electronic device 300 may operate in an operation mode for identifying information on a user. The smart ring device 200 may identify (or obtain) the information (e.g., health information) on the user using a PPG sensor 233. The smart ring device 200 may transmit the information on the user to the external electronic device 300. The external electronic device 300 may provide a service based on the information on the user.

In operation 3103, at least one of the smart ring device 200 and the external electronic device 300 may identify a connection event for a rotation input. For example, the connection event for the rotation input may include an event in which the smart ring device 200 and the external electronic device 300 are in contact with each other. For example, the connection event for the rotation input may include an event in which a specified application is executed (or activated). In response to the execution (or the activation) of the specified application, the external electronic device 300 may transmit a message for a connection request to the smart ring device 200. The smart ring device 200 may transmit a message for a connection response to the external electronic device 300. The smart ring device 200 and the external electronic device 103 may establish a connection for the rotation input based on the message for the connection response.

The smart ring device 200 may activate a function for identifying the rotation input, based on the connection event for the rotation input. The external electronic device 300 may activate a function for receiving information on the rotation input from the smart ring device 200, based on the connection event for the rotation input.

In operation 3104, the smart ring device 200 may request, from the external electronic device 300, the connection for the rotation input. The operation 3104 may correspond to the operation 2712 of FIG. 27.

In operation 3105, the external electronic device 300 may transmit, to the smart ring device 200, a message to acknowledge the connection for the rotation input. The operation 3105 may correspond to the operation 2713 of FIG. 27.

In operation 3106, the external electronic device 300 may perform a function of the external electronic device 300 according to a rotation input of the smart ring device 200. The operation 3106 may correspond to the operation 2714 of FIG. 27.

Referring to the operation 3101 to the operation 3106, even when the smart ring device 200 and the external electronic device 300 are connected, the smart ring device 200 may not transmit, to the external electronic device 300, the information on the rotation input. For example, the smart ring device 200 may transmit, to the external electronic device 300, the information on the rotation input based on the contact with the external electronic device 300. For example, based on the execution of the specified application in the external electronic device 300, the smart ring device 200 may transmit, to the external electronic device 300, the information on the rotation input. According to an embodiment of the disclosure, in a case that the specified application is not executed, a specified operation may be performed in a system UI based on the rotation input of the smart ring device 200. According to an embodiment of the disclosure, in a case that a module for processing (or receiving) the rotation input exists in an application or a function, the rotation input may be processed through the module as the application or the function is activated.

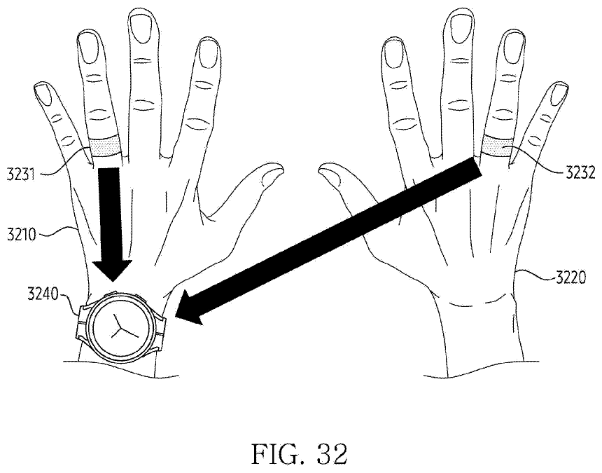

FIG. 32 illustrates an operation of a plurality of smart ring devices and an external electronic device according to an embodiment of the disclosure.

Referring to FIG. 32, a user may wear the plurality of smart ring devices and the external electronic device. For example, the user may wear a first smart ring device 3231, a second smart ring device 3232, and an external electronic device 3240.

The first smart ring device 3231 may be worn on a finger of a left hand 3210 of the user. The second smart ring device 3232 may be worn on a finger of a right hand 3220 of the user. The external electronic device 3240 may be worn on a wrist of the left hand 3210 of the user.

According to an embodiment of the disclosure, the external electronic device 3240 may provide data on a smart ring device based on mutual directionality between the external electronic device 3240 and the smart ring device (e.g., the first smart ring device 3231 and the second smart ring device 3232).

For example, the external electronic device 3240 may identify a device for performing a function of the external electronic device 3240 as one of the first smart ring device 3231 and the second smart ring device 3232. The external electronic device 3240 may include a rotatable wheel key (or bezel). Based on rotation with respect to the wheel key, the external electronic device 3240 may set the device for performing the function of the external electronic device 3240 as one of the first smart ring device 3231 and the second smart ring device 3232. Based on the wheel key rotating counterclockwise, the first smart ring device 3231 may be selected as the device for performing the function of the external electronic device 3240. Based on the wheel key rotating clockwise, the second smart ring device 3232 may be selected as the device for performing the function of the external electronic device 3240.

A rotation input identified by one of the first smart ring device 3231 and the second smart ring device 3232 set based on the rotation with respect to the wheel key may be mapped to at least one function of the external electronic device 3240.

According to an embodiment of the disclosure, a smart ring device may comprise a housing comprising an external housing portion and an inner housing portion which is at least partially transparent, a light emitter configured to emit light through the inner housing portion, a first light receiver configured to receive the light reflected from at least a part of a user's finger, a second light receiver configured to receive the light reflected from the at least a part of the user's finger, and a processor. The processor may be configured to determine a wearing direction of the smart ring device using a first signal identified by the first light receiver and a second signal identified by the second light receiver.

According to an embodiment of the disclosure, the smart ring device may comprise a third light receiver and a fourth light receiver configured to receive the light reflected from the at least a part of the user's finger. The processor may be configured to determine the wearing direction of the smart ring device using the first signal, the second signal, a third signal, and a fourth signal identified by the first light receiver, the second light receiver, the third light receiver, and the fourth light receiver, respectively.

According to an embodiment of the disclosure, the first light receiver and the second light receiver may be configured as one sensor. The first light receiver may comprise at least one photodiode related to the sensor. The second light receiver may comprise at least one other photodiode related to the sensor.

According to an embodiment of the disclosure, the first signal may comprise a first value corresponding to intensity of the light reflected from the at least a part of the user's finger. The second signal may comprise a second value corresponding to intensity of the light reflected from the at least a part of the user's finger. The processor may be configured to determine the wearing direction of the smart ring device based on the first value and the second value.

According to an embodiment of the disclosure, the processor may be configured to determine the wearing direction of the smart ring device based on an amount of change in the first value and an amount of change in the second value.

According to an embodiment of the disclosure, the processor may be configured to obtain at least one biometric information using the light emitter, the first light receiver, and the second light receiver.

According to an embodiment of the disclosure, the processor may be configured to determine the wearing direction of the smart ring device based on performing a first light emission using the light emitter. The processor may be configured to obtain the at least one biometric information based on performing a second light emission distinct from the first light emission using the light emitter. The second light emission may be different from the first light emission in at least one of light intensity, emission time, or an emission period.

According to an embodiment of the disclosure, the processor may be configured to determine, using the first light receiver or the second light receiver, light intensity of an environment. The processor may be configured to, based on the light intensity of the environment, adjust at least one of the intensity of the light emitted through the light emitter, the emission time, or the emission period to determine the wearing direction of the smart ring device.

According to an embodiment of the disclosure, the processor may be configured to adjust a threshold value for determining the wearing direction of the smart ring device based on the light intensity of the environment.

According to an embodiment of the disclosure, the smart ring device may comprise an acceleration sensor. The processor may be configured to detect, using the acceleration sensor, a movement of the smart ring device. The processor may be configured to determine the wearing direction of the smart ring device based on the movement of the smart ring device.

According to an embodiment of the disclosure, the processor may be configured to determine a direction of a user input based on the determined wearing direction.

According to an embodiment of the disclosure, the processor may be configured to identify, using the acceleration sensor, a posture of the smart ring device. The processor may be configured to, based at least in part on a determination that the posture of the smart ring device corresponds to a first posture, perform up or down scrolling according to the user input. The processor may be further configured to, based at least in part on a determination that the posture of the smart ring device corresponds to a second posture, perform left or right scrolling according to the user input.

According to an embodiment of the disclosure, the processor may be configured to transmit information corresponding to the wearing direction to an external electronic device for representing at least one indication indicative of the wearing direction via a display of the external electronic device operatively connected with the smart ring device.

According to an embodiment of the disclosure, the smart ring device may comprise a first antenna configured to emit a signal in a first direction, and a second antenna configured to emit the signal in a second direction different from the first direction. The processor may be configured to transmit the signal using the first antenna or the second antenna based on the wearing direction of the smart ring device.

According to an embodiment of the disclosure, the smart ring device may comprise a structure rotatable on the external housing portion based on a center of a hole of the smart ring device, and a rotation detection sensor to identify a direction of rotation of the structure.

According to an embodiment of the disclosure, the processor may be configured to identify that the smart ring device is contacted on a housing of an external electronic device. The processor may be configured to, based on identifying that the smart ring device is contacted on the housing of the external electronic device, establish a connection with the external electronic device.

According to an embodiment of the disclosure, the processor may be configured to, while the smart ring device is contacted on the housing of the external electronic device, based on rotation of the structure, identify a rotation input. The processor may be configured to, based on the rotation input, perform a function set according to the wearing direction of the smart ring device.

According to an embodiment of the disclosure, the smart ring device may comprise a touch sensor for identifying contact of the user's body on the external housing portion. The processor may be configured to, based on identifying one of a first touch input maintained along a first direction on the external housing portion and a second touch input maintained along a second direction opposite to the first direction on the external housing portion, identify a rotation input.

According to an embodiment of the disclosure, a method performed by a smart ring device may comprise emitting, using a light emitter included in the smart ring device, light. The method may comprise determining a wearing direction of the smart ring device using a first signal identified by a first light receiver comprised in the smart ring device based on the light reflected from at least a part of a user's finger and a second signal identified by a second light receiver comprised in the smart ring device based on the light reflected from the at least a part of the user's finger.

According to an embodiment of the disclosure, the first signal may comprise a first value corresponding to intensity of the light reflected from the at least a part of the user's finger. The second signal may comprise a second value corresponding to intensity of the light reflected from the at least a part of the user's finger. The method may comprise determining the wearing direction of the smart ring device based on the first value and the second value.

According to an embodiment of the disclosure, the method may comprise determining the wearing direction of the smart ring device based on an amount of change in the first value and an amount of change in the second value.

According to an embodiment of the disclosure, the method may comprise obtaining at least one biometric information using the light emitter, the first light receiver, and the second light receiver.

According to an embodiment of the disclosure, a non-transitory computer readable storage medium may store one or more programs. The one or more programs may comprise instructions, which, when executed by a processor of a smart ring device with a light emitter, a first light receiver, and a second light receiver, cause the smart ring device to emit, using the light emitter, light. The one or more programs may comprise instructions, which, when executed by the processor, cause the smart ring device to determine a wearing direction of the smart ring device using a first signal identified by the first light receiver based on the light reflected from at least a part of a user's finger and a second signal identified by the second light receiver based on the light reflected from the at least a part of the user's finger.

According to an embodiment of the disclosure, a smart ring device may comprise a housing comprising an external housing portion and an inner housing portion which is at least partially transparent, a light emitter configured to emit light through the inner housing portion, a first light receiver configured to receive the light reflected from at least a part of a user's finger, a second light receiver configured to receive the light reflected from the at least a part of the user's finger, at least one processor including processing circuitry, and memory comprising one or more storage media storing instructions. The instructions, when executed by the at least one processor individually or collectively, may cause the smart ring device to determine a wearing direction of the smart ring device using a first signal identified by the first light receiver and a second signal identified by the second light receiver.

For example, the smart ring device may comprise a third light receiver and a fourth light receiver configured to receive the light reflected from the at least a part of the user's finger. The instructions, when executed by the at least one processor individually or collectively, may cause the smart ring device to determine the wearing direction of the smart ring device using the first signal, the second signal, a third signal, and a fourth signal identified by the first light receiver, the second light receiver, the third light receiver, and the fourth light receiver, respectively.

For example, the first light receiver and the second light receiver may be configured as one sensor. The first light receiver may comprise at least one photodiode related to the sensor. The second light receiver may comprise at least one other photodiode related to the sensor.

For example, the first signal may comprise a first value corresponding to intensity of the light reflected from the at least a part of the user's finger. The second signal may comprise a second value corresponding to intensity of the light reflected from the at least a part of the user's finger. The instructions, when executed by the at least one processor individually or collectively, may cause the smart ring device to determine the wearing direction of the smart ring device based on the first value and the second value.

For example, the instructions, when executed by the at least one processor individually or collectively, may cause the smart ring device to determine the wearing direction of the smart ring device based on an amount of change in the first value and an amount of change in the second value.

For example, the instructions, when executed by the at least one processor individually or collectively, may cause the smart ring device to obtain at least one biometric information using the light emitter, the first light receiver, and the second light receiver.

For example, the instructions, when executed by the at least one processor individually or collectively, may cause the smart ring device to determine the wearing direction of the smart ring device based on performing a first light emission using the light emitter. The instructions, when executed by the at least one processor individually or collectively, may cause the smart ring device to obtain the at least one biometric information based on performing a second light emission distinct from the first light emission using the light emitter. The second light emission may be different from the first light emission in at least one of light intensity, emission time, or an emission period.

For example, the instructions, when executed by the at least one processor individually or collectively, may cause the smart ring device to determine, using the first light receiver or the second light receiver, light intensity of an environment. The instructions, when executed by the at least one processor individually or collectively, may cause the smart ring device to, based on the light intensity of the environment, adjust at least one of the intensity of the light emitted through the light emitter, the emission time, or the emission period to determine the wearing direction of the smart ring device.

For example, the instructions, when executed by the at least one processor individually or collectively, may cause the smart ring device to adjust a threshold value for determining the wearing direction of the smart ring device based on the light intensity of the environment.

For example, the smart ring device may comprise an acceleration sensor. The instructions, when executed by the at least one processor individually or collectively, may cause the smart ring device to detect, using the acceleration sensor, a movement of the smart ring device. The instructions, when executed by the at least one processor individually or collectively, may cause the smart ring device to determine the wearing direction of the smart ring device based on the movement of the smart ring device.

For example, the instructions, when executed by the at least one processor individually or collectively, may cause the smart ring device to determine a direction of a user input based on the determined wearing direction.

For example, the instructions, when executed by the at least one processor individually or collectively, may cause the smart ring device to identify, using the acceleration sensor, a posture of the smart ring device. The instructions, when executed by the at least one processor individually or collectively, may cause the smart ring device to, based at least in part on a determination that the posture of the smart ring device corresponds to a first posture, perform up or down scrolling according to the user input. The instructions, when executed by the at least one processor individually or collectively, may cause the smart ring device to, based at least in part on a determination that the posture of the smart ring device corresponds to a second posture, perform left or right scrolling according to the user input.

For example, the instructions, when executed by the at least one processor individually or collectively, may cause the smart ring device to transmit information corresponding to the wearing direction to an external electronic device for representing at least one indication indicative of the wearing direction via a display of the external electronic device operatively connected with the smart ring device.

According to an embodiment of the disclosure, a method performed by a smart ring device may comprise emitting, using a light emitter included in the smart ring device, light. The method may comprise determining a wearing direction of the smart ring device using a first signal identified by a first light receiver comprised in the smart ring device based on the light reflected from at least a part of a user's finger and a second signal identified by a second light receiver comprised in the smart ring device based on the light reflected from the at least a part of the user's finger.

According to an embodiment of the disclosure, a non-transitory computer readable storage medium may store one or more programs. The one or more programs may comprise instructions, which, when executed by a processor of a smart ring device with a light emitter, a first light receiver, and a second light receiver, cause the smart ring device to emit, using the light emitter, light. The one or more programs may comprise instructions, which, when executed by the processor, cause the smart ring device to determine a wearing direction of the smart ring device using a first signal identified by the first light receiver based on the light reflected from at least a part of a user's finger and a second signal identified by the second light receiver based on the light reflected from the at least a part of the user's finger.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment of the disclosure. the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment of the disclosure, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments of the disclosure, each component (e.g., a module or a program) of the above-described components may include a single entity or multiple entities, and some of the multiple entities may be separately disposed in different components. According to various embodiments of the disclosure, one or more of the above-described components may be omitted, or one or more other components may be added. Alternatively or additionally, a plurality of components (e.g., modules or programs) may be integrated into a single component. In such a case, according to various embodiments of the disclosure, the integrated component may still perform one or more functions of each of the plurality of components in the same or similar manner as they are performed by a corresponding one of the plurality of components before the integration. According to various embodiments of the disclosure, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method of any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A smart ring device comprising:
a housing comprising an external housing portion and an inner housing portion which is at least partially transparent;
a light emitter configured to emit light through the inner housing portion;
a first light receiver configured to receive the light reflected from at least a part of a user's finger;
a second light receiver configured to receive the light reflected from the at least a part of the user's finger;
memory, comprising one or more storage media, storing instructions; and
at least one processor including processing circuitry communicatively coupled to the memory,
wherein the instructions, when executed by the at least one processor individually or collectively, cause the smart ring device to determine a wearing direction of the smart ring device using a first signal identified by the first light receiver and a second signal identified by the second light receiver.

2. The smart ring device of claim 1,
wherein the smart ring device further comprises a third light receiver and a fourth light receiver configured to receive the light reflected from the at least a part of the user's finger, and
wherein the instructions, when executed by the at least one processor individually or collectively, further cause the smart ring device to determine the wearing direction of the smart ring device using the first signal, the second signal, a third signal, and a fourth signal identified by the first light receiver, the second light receiver, the third light receiver, and the fourth light receiver respectively.

3. The smart ring device of claim 1,
wherein the first light receiver and the second light receiver are configured as one sensor,
wherein the first light receiver comprises at least one photodiode related to the sensor, and
wherein the second light receiver comprises at least one other photodiode related to the sensor.

4. The smart ring device of claim 1,
wherein the first signal comprises a first value corresponding to intensity of the light reflected from the at least a part of the user's finger,
wherein the second signal comprises a second value corresponding to intensity of the light reflected from the at least a part of the user's finger, and
wherein the instructions, when executed by the at least one processor individually or collectively, further cause the smart ring device to determine the wearing direction of the smart ring device based on the first value and the second value.

5. The smart ring device of claim 4, wherein the instructions, when executed by the at least one processor individually or collectively, further cause the smart ring device to determine the wearing direction of the smart ring device based on an amount of change in the first value and an amount of change in the second value.

6. The smart ring device of claim 1, wherein the instructions, when executed by the at least one processor individually or collectively, further cause the smart ring device to obtain at least one biometric information using the light emitter, the first light receiver and the second light receiver.

7. The smart ring device of claim 6,
wherein the instructions, when executed by the at least one processor individually or collectively, further cause the smart ring device to:
determine the wearing direction of the smart ring device based on performing a first light emission using the light emitter, and
obtain the at least one biometric information based on performing a second light emission distinct from the first light emission using the light emitter, and
wherein the second light emission is different from the first light emission in at least one of light intensity, emission time, or an emission period.

8. The smart ring device of claim 1, wherein the instructions, when executed by the at least one processor individually or collectively, further cause the smart ring device to:
determine, using the first light receiver or the second light receiver, light intensity of an environment, and
based on the light intensity of the environment, adjust at least one of the light intensity emitted through the light emitter, emission time, or emission period to determine the wearing direction of the smart ring device.

9. The smart ring device of claim 8, wherein the instructions, when executed by the at least one processor individually or collectively, further cause the smart ring device to adjust a threshold value for determining the wearing direction of the smart ring device based on the light intensity of the environment.

10. The smart ring device of claim 1,
wherein the smart ring device further comprises an acceleration sensor, and
wherein the instructions, when executed by the at least one processor individually or collectively, further cause the smart ring device to:
detect, using the acceleration sensor, a movement of the smart ring device, and
determine the wearing direction of the smart ring device based on the movement of the smart ring device.

11. The smart ring device of claim 10, wherein the instructions, when executed by the at least one processor individually or collectively, further cause the smart ring device to determine a direction of a user input based on the determined wearing direction.

12. The smart ring device of claim 11, wherein the instructions, when executed by the at least one processor individually or collectively, further cause the smart ring device to:
identify, using the acceleration sensor, a posture of the smart ring device,
based at least in part on a determination that the posture of the smart ring device corresponds to a first posture, perform up or down scrolling according to the user input, and
based at least in part on a determination that the posture of the smart ring device corresponds to a second posture, perform left or right scrolling according to the user input.

13. The smart ring device of claim 1, wherein the instructions, when executed by the at least one processor individually or collectively, further cause the smart ring device to transmit information corresponding to the wearing direction to an external electronic device for representing at least one indication indicative of the wearing direction via a display of the external electronic device operatively connected with the smart ring device.

14. The smart ring device of claim 1,
wherein the smart ring device further comprises:
a first antenna configured to emit a signal in a first direction, and
a second antenna configured to emit the signal in a second direction different from the first direction, and
wherein the instructions, when executed by the at least one processor individually or collectively, further cause the smart ring device to transmit the signal using the first antenna or the second antenna based on the wearing direction of the smart ring device.

15. The smart ring device of claim 1, wherein the smart ring device further comprises:
a structure rotatable on the external housing portion based on a center of a hole of the smart ring device; and
a rotation detection sensor to identify a direction of rotation of the structure.

16. A method performed by a smart ring device, the method comprising:
emitting, using a light emitter included in the smart ring device, light; and
determining a wearing direction of the smart ring device using a first signal identified by a first light receiver comprised in the smart ring device based on the light reflected from at least a part of a user's finger and a second signal identified by a second light receiver comprised in the smart ring device based on the light reflected from the at least a part of the user's finger.

17. The method of claim 16,
wherein the first signal comprises a first value corresponding to intensity of the light reflected from the at least a part of the user's finger,
wherein the second signal comprises a second value corresponding to intensity of the light reflected from the at least a part of the user's finger, and
wherein the method further comprises determining the wearing direction of the smart ring device based on the first value and the second value.

18. The method of claim 17, further comprising:
determining the wearing direction of the smart ring device based on an amount of change in the first value and an amount of change in the second value.

19. The method of claim 16, wherein the method further comprises obtaining at least one biometric information using the light emitter, the first light receiver, and the second light receiver.

20. One or more non-transitory computer-readable storage media storing one or more computer programs including computer-executable instructions that, when executed by at least one processor of a smart ring device with a light emitter, a first light receiver, and a second light receiver individually or collectively, cause the smart ring device to perform operations, the operations comprising:
emitting, using the light emitter, light; and
determining a wearing direction of the smart ring device using a first signal identified by the first light receiver based on the light reflected from at least a part of a user's finger and a second signal identified by the second light receiver based on the light reflected from the at least a part of the user's finger.
